(19) United States
(12) Patent Application Publication
(10) Pub. No.: US 2017/0286572 A1
(43) Pub. Date: Oct. 5, 2017

(54) DIGITAL TWIN OF TWINNED PHYSICAL SYSTEM

(71) Applicant: General Electric Company, Schenectady, NY (US)

(72) Inventors: John Erik HERSHEY, Ballston Lake, NY (US); Frederick Wilson WHEELER, Niskayuna, NY (US); Matthew Christian NIELSEN, Erie, PA (US); Christopher Donald JOHNSON, Niskayuna, NY (US); Michael Joseph DELL'ANNO, Niskayuna, NY (US); Joij JOYKUTTI, Bangalore (IN)

(21) Appl. No.: 15/087,217

(22) Filed: Mar. 31, 2016

(51) Int. Cl. G06F 17/50; G06F 17/18

(52) U.S. Cl. CPC G06F 17/5009; G06F 17/18

(57) ABSTRACT

An apparatus may implement a digital twin of a twinned physical system such that one or more sensors to sense values of one or more designated parameters of the twinned physical system. A computer processor may receive data associated with the sensors and, for at least a selected portion of the twinned physical system, monitor a condition of the selected portion of the twinned physical system and/or assess a remaining useful life of the selected portion based at least in part on the sensed values of the one or more designated parameters. A communication port may transmit information associated with a result generated by the computer processor. The one or more sensors may sense values of the one or more designated parameters, and the computer processor may perform the monitoring and/or assessing, when the twinned physical system is not operating.

### BACKGROUND

It is often desirable to make assessment and/or predictions regarding the operation of a real world physical system, such as an electro-mechanical system. For example, it may be helpful to predict a Remaining Useful Life (“RUL”) of an electro-mechanical system, such as an aircraft engine, to help plan when the system should be replaced. Likewise, an owner or operator of a system might want to monitor a condition of the system, or a portion of the system, to help make maintenance decisions, budget predictions, etc. Even with improvements in sensor and computer technologies, however, accurately making such assessments and/or predictions can be a difficult task. For example, an event that occurs while a system is not operating might impact the RUL and/or condition of the system but not be taken into account by typical approaches to system assessment and/or prediction processes.

It would therefore be desirable to provide systems and methods to facilitate assessments and/or predictions for a physical system in an automatic and accurate manner.

### SUMMARY

According to some embodiments, an apparatus may implement a digital twin of a twinned physical system such that one or more sensors sense values of one or more designated parameters of the twinned physical system. A computer processor may receive data associated with the sensors and, for at least a selected portion of the twinned physical system, monitor a condition of the selected portion of the twinned physical system and/or assess a remaining useful life of the selected portion based at least in part on the sensed values of the one or more designated parameters. A communication port may transmit information associated with a result generated by the computer processor. The one or more sensors may sense values of the one or more designated parameters, and the computer processor may perform the monitoring and/or assessing, when the twinned physical system is not operating.

Some embodiments comprise: means for sensing, by one or more sensors, one or more designated parameters of the twinned physical system; for at least a selected portion of the twinned physical system, means for executing by a computer processor at least one of: (i) a monitoring process to monitor a condition of the selected portion of the twinned physical system based at least in part on the sensed values of the one or more designated parameters, and (ii) an assessing process to assess a remaining useful life of the selected portion of the twinned physical system based at least in part on the sensed values of the one or more designated parameters; and means for transmitting, via a communication port coupled to the computer processor, information associated with a result generated by the computer processor, wherein the one or more sensors are to sense values of the one or more designated parameters, and the computer processor is to execute at least one of the monitoring and assessing processes, when the twinned physical system is not operating.

A technical advantage of some embodiments disclosed herein are improved systems and methods to facilitate assessments and/or predictions for a physical system in an automatic and accurate manner.

### BRIEF DESCRIPTION OF THE DRAWINGS

FIG. 1A is a high-level block diagram of a system that may be provided in accordance with some embodiments.

FIG. 1B is a digital twin method according to some embodiments.

FIG. 2A illustrates integration of some physical computer models.

FIG. 2B illustrates six modules that may comprise a digital twin according to some embodiments.

FIG. 3 illustrates an example of a digital twin's functions.

FIG. 4 illustrates off-line examination in accordance with some embodiments.

FIG. 5 illustrates one example of an on-line exceedance handling procedure.

FIG. 6 illustrates one example of a comprehensive monitoring envelope.

FIG. 7 illustrates temperatures and claim percentages according to some embodiments.

FIG. 8 illustrates dimensional expansion of ICC component dimensions.

FIG. 9 illustrates partitioning of digital twin software code in accordance with some embodiments.

FIG. 10 illustrates different configurations for connecting components to computational associates.

FIG. 11 illustrates communication latencies and moments according to some embodiments.

FIG. 12 illustrates an example layout of entities involved in physical system modeling.

FIG. 13 illustrates a flow chart of steps associated with the FIG. 12 layout.

FIG. 14 illustrates some different configurations for connecting components to the computational associates.

FIG. 15 illustrates a rigid member subject to forces according to some embodiments.

FIG. 16 illustrates a developed crack in the rigid member.

FIG. 17 illustrates a sequence of force values according to some embodiments.

FIG. 18 illustrates a fuzzy representation of force values in accordance with some embodiments.

FIG. 19 illustrates a bridge between digital and fuzzy value representations.

FIG. 20 illustrates a method and system for detection of sensor incompetence.

FIG. 21 illustrates an exemplary plot of EGT data according to some embodiments.

FIG. 22 illustrates three different domains of interacting digital twins according to some embodiments.

FIG. 23 illustrates a confounding experiment with eight interacting digital twins in accordance with some embodiments.

FIG. 24 is block diagram of a digital twin platform according to some embodiments of the present invention.

FIG. 25 is a tabular portion of a digital twin database according to some embodiments.

FIG. 26 illustrates an interactive graphical user interface display according to some embodiments.

### DETAILED DESCRIPTION

In the following detailed description, numerous specific details are set forth in order to provide a thorough understanding of embodiments. However it will be understood by those of ordinary skill in the art that the embodiments may be practiced without these specific details. In other instances, well-known methods, procedures, components and circuits have not been described in detail so as not to obscure the embodiments.

It is often desirable to make assessment and/or predictions regarding the operation of a real world physical system, such as an electro-mechanical system. For example, it may be helpful to predict the Remaining Useful Life (“RUL”) of an electro-mechanical system, such as an aircraft engine, to help plan when the system should be replaced. In some cases, an expected useful life of a system may be estimated by a calculation process involving the probabilities of failure of the system's individual components, the individual components having their own reliability measures and distributions. Such an approach, however, might tend to more reactive than proactive.

With the advancement of sensors, communications, and computational modeling, it may be possible to consider multiple components of a system, each having its own micro-characteristics and not just average measures of a plurality of components associated with a production run or lot. Moreover, it may be possible to very accurately monitor and continually assess the health of individual components, predict their remaining lives, and consequently estimate the health and remaining useful lives of systems that employ them. This would be a significant advance for applied prognostics, and discovering a system and methodology to do so in an accurate and efficient manner will help reduce unplanned down time for complex systems (resulting in cost savings and increased operational efficiency). It may also be possible to achieve a more nearly optimal control of an asset if the life of the parts can be accurately determined as well as any degradation of the key components. According to some embodiments described herein, this information may be provided by a “digital twin” of a twinned physical system.

A digital twin may estimate a remaining useful life of a twinned physical system using sensors, communications, modeling, history, and computation. It may provide an answer in a time frame that is useful, that is, meaningfully prior to a projected occurrence of a failure event or suboptimal operation. It might comprise a code object with parameters and dimensions of its physical twin's parameters and dimensions that provide measured values, and keeps the values of those parameters and dimensions current by receiving and updating values via outputs from sensors embedded in the physical twin. The digital twin may be, according to some embodiments, upgraded upon occurrence of unpredicted events and other data, such as the discovery and identification of exogenous variables, which may enhance accuracy. The digital twin may also be used to prequalify a twinned physical system's reliability for a planned mission. The digital twin may comprise a real time efficiency and life consumption state estimation device. It may comprise a specific, or “per asset,” portfolio of system models and asset specific sensors. It may receive inspection and/or operational data and track a single specific asset over its lifetime with observed data and calculated state changes. Some digital twin models may include a functional or mathematical form that is the same for like asset systems, but will have tracked parameters and state variables that are specific to each individual asset system.

A twinned physical system may be either operating or non-operating. When non-operating, the digital twin may remain operational and its sensors may keep measuring their assigned parameters. In this way, a digital twin may still make accurate assessments and predictions even when the twinned physical system is altered or damaged in a non-operational state. Note that if the digital twin and its sensors were also non-operational, the digital twin might be unaware of significant events of interest.

A digital twin may be placed on a twinned physical system and run autonomously or globally with a connection to external resources using the Internet of Things (IoT) or other data services. Note that an instantiation of the digital twin's software could take place at multiple locations. A digital twin's software could reside near the asset and used to help control the operation of the asset. Another location might be at a plant or farm level, where system level digital twin models may be used to help determine optimal operating conditions for a desired outcome, such as minimum fuel usage to achieve a desired power output of a power plant. In addition, a digital twin's software could reside in the cloud, implemented on a server remote from the asset. The advantages of such a location might include scalable computing resources to solve computationally intensive calculations required to converge a digital twin model producing an output vector y̅.

It should be noted that multiple but different digital twin models for a specific asset, such as a gas turbine, could reside at all three of these types of locations. Each location might, for example, be able to gather different data, which may allow for better observation of the asset states and hence determination of the tuning parameters, a, especially when the different digital twin models exchange information.

A “Per Asset” digital twin may be associated with a software model for a particular twinned physical system. The mathematical form of the model underlying similar assets may, according to some embodiments, be altered from like asset system to like asset system to match the particular configuration or mode of incorporation of each asset system. A Per Asset digital twin may comprise a model of the structural components, their physical functions, and/or their interactions. A Per Asset digital twin might receive sensor data from sensors that report on the health and stability of a system, environmental conditions, and/or the system's response and state in response to commands issued to the system. A Per Asset digital twin may also track and perform calculations associated with estimating a system's remaining useful life.

A Per Asset digital twin may comprise a mathematical representation or model along with a set of tuned parameters that describe the current state of the asset. This is often done with a kernel-model framework, where a kernel represents the baseline physics of operation or phenomenon of interest pertaining to the asset. The kernel has a general form of:

y̅=f(ā,x̅)

where ā is a vector containing a set of tuning parameters that are specific to the asset and its current state. Examples may include component efficiencies in different sections of an aircraft engine or gas turbine. The vector x̅ contains the kernel inputs, such as operating conditions (fuel flow, altitude, ambient temperature, pressure, etc.). Finally, the vector y̅ is the kernel outputs which could include sensor measurement estimates or asset states (part life damage states, etc.).

When a kernel is tuned to a specific asset, the vector ā is determined, and the result is called the Per Asset digital twin model. The vector ā will be different for each asset and will change over its operational life. The Component Dimensional Value table (“CDV”) may record the vector ā. It may be advantageous to keep all computed vector ā's versus time to then perform trending analyses or anomaly detection.

A Per Asset digital twin may be configured to function as a continually tuned digital twin, a digital twin that is continually updated as its twinned physical system is on-operation, an economic operations digital twin used to create demonstrable business value, an adaptable digital twin that is designed to adapt to new scenarios and new system configurations and may be transferred to another system or class of systems, and/or one of a plurality of interacting digital twins that are scalable over an asset class and may be broadened to not only model a twinned physical system but also provide control over the asset.

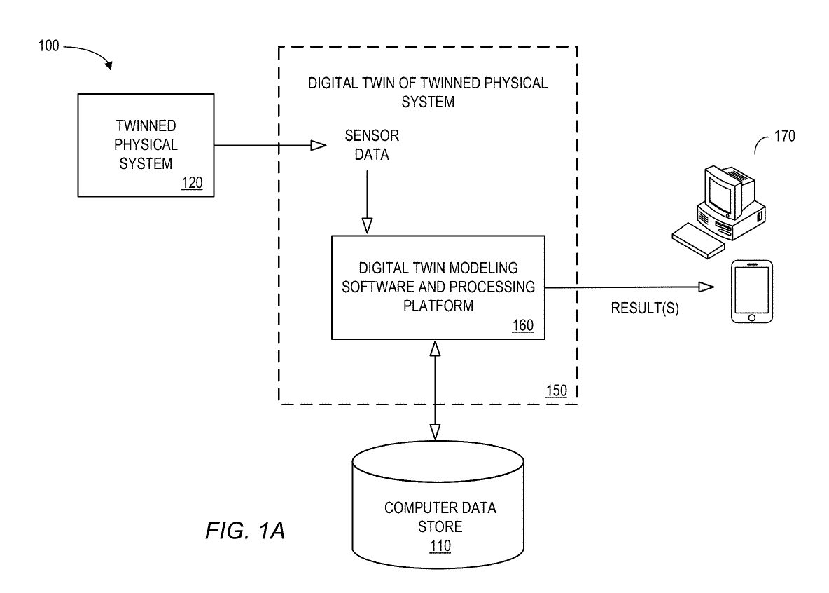

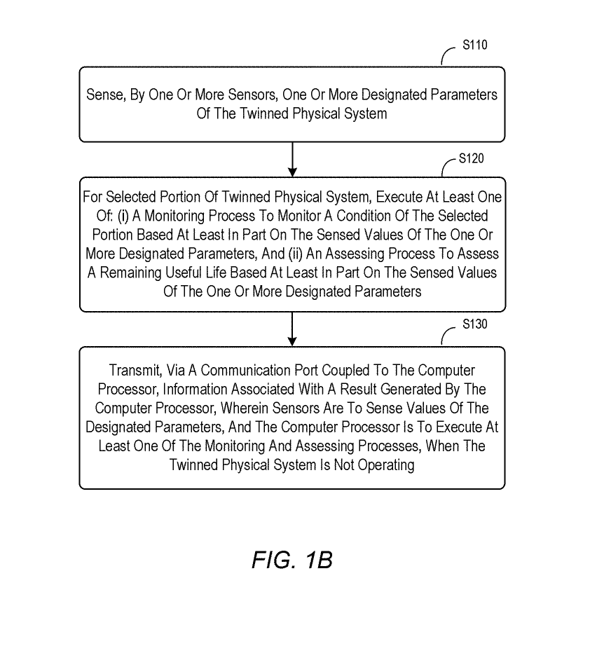

FIG. 1A is a high-level architecture of a system 100 in accordance with some embodiments. The system 100 includes a computer data store 110 that provides information to a digital twin of twinned physical asset or system 150. Data in the data store 110 might include, for example, information about a twinned physical system 120, such as historic engine sensor information about a number of different aircraft engines and prior aircraft flights (e.g., external temperatures, exhaust gas temperatures, engine model numbers, takeoff and landing airports, etc.).

The digital twin of twinned physical system 150 may, according to some embodiments, access the data store 110, and utilize a probabilistic model creation unit to automatically create a predictive model that may be used by a digital twin modeling software and processing platform to create a prediction and/or result that may be transmitted to various user platforms 170 as appropriate (e.g., for display to a user). As used herein, the term “automatically” may refer to, for example, actions that can be performed with little or no human intervention.

As used herein, devices, including those associated with the system 100 and any other device described herein, may exchange information via any communication network which may be one or more of a Local Area Network (“LAN”), a Metropolitan Area Network (“MAN”), a Wide Area Network (“WAN”), a proprietary network, a Public Switched Telephone Network (“PSTN”), a Wireless Application Protocol (“WAP”) network, a Bluetooth network, a wireless LAN network, and/or an Internet Protocol (“IP”) network such as the Internet, an intranet, or an extranet. Note that any devices described herein may communicate via one or more such communication networks.

The digital twin of twinned physical system 150 may store information into and/or retrieve information from various data sources, such as the computer data store 110 and/or user platforms 170. The various data sources may be locally stored or reside remote from the digital twin of twinned physical system 150. Although a single digital twin of twinned physical system 150 is shown in FIG. 1A, any number of such devices may be included. Moreover, various devices described herein might be combined according to embodiments of the present invention. For example, in some embodiments, the digital twin of twinned physical system 150 and one or more data sources might comprise a single apparatus. The digital twin software of twinned physical system 150 function may be performed by a constellation of networked apparatuses, in a distributed processing or cloud-based architecture.

A user may access the system 100 via one of the user platforms 170 (e.g., a personal computer, tablet, or smartphone) to view information about and/or manage a digital twin in accordance with any of the embodiments described herein. According to some embodiments, an interactive graphical display interface may let an operator define and/or adjust certain parameters and/or provide or receive automatically generated recommendations or results. For example, FIG. 1B illustrates a method that might be performed by some or all of the elements of the system 100 described with respect to FIG. 1A. The flow charts described herein do not imply a fixed order to the steps, and embodiments of the present invention may be practiced in any order that is practicable. Note that any of the methods described herein may be performed by hardware, software, or any combination of these approaches. For example, a computer-readable storage medium may store thereon instructions that when executed by a machine result in performance according to any of the embodiments described herein.

At S110, one or more sensors may sense one or more designated parameters of a twinned physical system. For at least a selected portion of the twinned physical system, a computer processor may execute at S120 at least one of: (i) a monitoring process to monitor a condition of the selected portion of the twinned physical system based at least in part on the sensed values of the one or more designated parameters, and (ii) an assessing process to assess a remaining useful life of the selected portion of the twinned physical system based at least in part on the sensed values of the one or more designated parameters. At S130, information associated with a result generated by the computer processor is transmitted via a communication port coupled to the computer processor. Note that, according to some embodiments, the one or more sensors are to sense values of the one or more designated parameters, and the computer processor is to execute at least one of the monitoring and assessing processes, even when the twinned physical system is not operating.

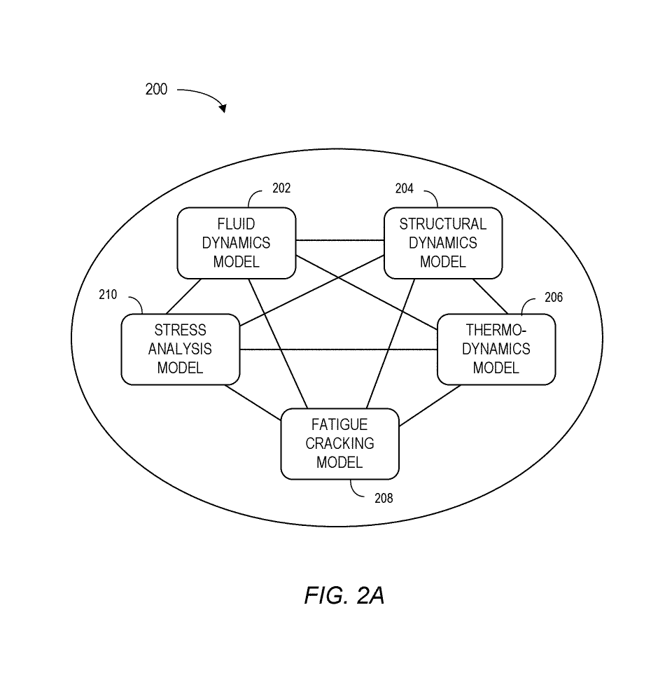

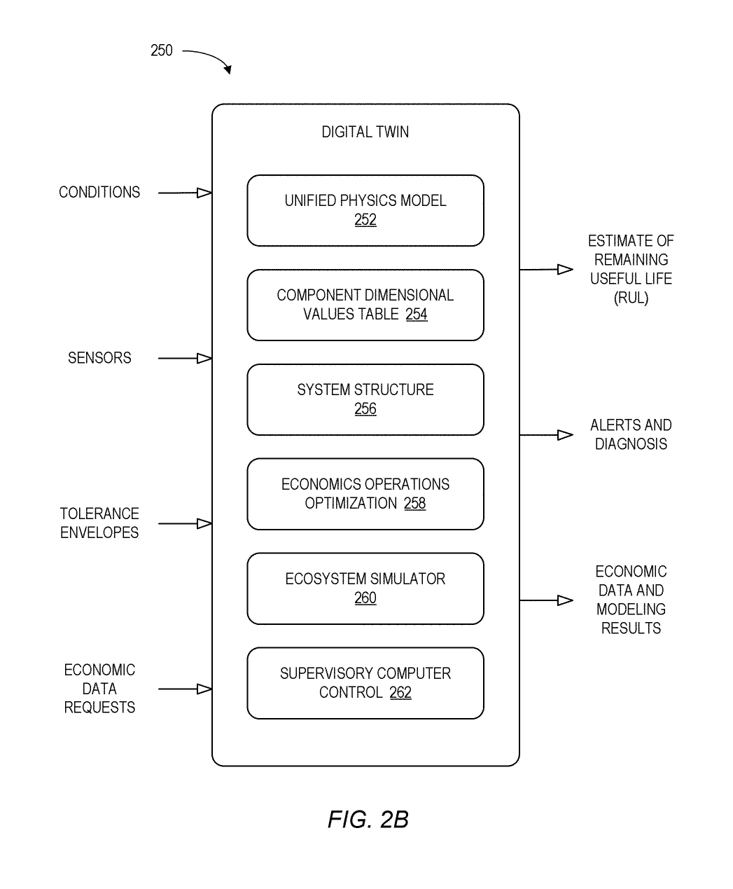

According to some embodiments described herein, a digital twin may have two functions: monitoring a twinned physical system and performing prognostics on it. Another function of a digital twin may comprise a limited or total control of the twinned physical system. In one embodiment, a digital twin of a twinned physical system consists of (1) one or more sensors sensing the values of designated parameters of the twinned physical system and (2) an ultra-realistic computer model of all of the subject system's multiple elements and their interactions under a spectrum of conditions. This may be implemented using a computer model having substantial number of degrees of freedom and may be associated with, as illustrated 200 in FIG. 2A, an integration of complex physical models for computational fluid dynamics 202, structural dynamics 204, thermodynamic modeling 206, stress analysis modeling 210, and/or a fatigue cracking model 208. Such an approach may be associated with, for example, a Unified Physics Model (“UPM”). Moreover, embodiments described herein may solving a resultant system of partial differential equations used in applied stochastic finite element methods, utilize a high performance computing resource, possibly on the scale of teraflops per second, and be implemented in usable manner.

Consider, for example, FIG. 2B which illustrates a digital twin 250 including such a UPM 252. The digital twin 250 may use algorithms, such as, but not limited to, an Extended Kalman Filter, to compare model predictions with measured data coming from a twinned physical system. The difference between predictions and the actual sensor data, called variances or innovations, may be used to tune internal model parameters such that the digital twin is 250 matched to the physical system. The digital twin's UPM 252 may be constructed such that it can adapt to varying environmental or operating conditions being seen by the actual twinned asset. The underlying physics-based equations may adapted to reflect the new reality experienced by the physical system

The digital twin 250 also includes a Component Dimensional Values (“CDV”) table 254 which might comprise a list of all of the physical components of the twinned physical system. Each component may be labeled with a unique identifier, such as an Internet Protocol version 6 (“IPv6”) address. Each component in the CDV table 254 may be associated with, or linked to, the values of its dimensions, the dimensions being the variables most important to the condition of the component. A Product Lifecycle Management (“PLM”) infrastructure, if beneficially utilized, may be internally consistent with CDV table 254 so as to enable lifecycle asset performance states as calculated by the digital twin 250 to be a closed loop model validation enablement for dimensional and performance calculations and assumptions. The number of the component's dimensions and their values may be expanded to accommodate storage and updating of values of exogenous variables discovered during operations of the digital twin.

The digital twin 250 may also include a system structure 256 which specifies the components of the twinned physical system and how the components are connected or interact with each other. The system structure 256 may also specify how the components react to input conditions that include environmental data, operational controls, and/or externally applied forces.

The digital twin 250 might also include an economic operations optimization 258 that governs the use and consumption of an industrial system to create operational and/or key process outcomes that result in financial returns and risks to those planned returns over an interval of time for the industrial system user and service providers. Similarly, the digital twin 250 might include an ecosystem simulator 260 that may allow all contributors to interact, not just at the physical layer, but virtually as well. Component suppliers, or anyone with expertise, might supply the digital twin models that will operate in the ecosystem and interact in mutually beneficial ways. The digital twin 250 may further include a supervisory computer control 262 that controls the overall function of the digital twin 250 and accepts inputs and produces outputs. The flow of data, data store, calculations, and/or computing required to calculate state and then subsequently use that performance and life state estimation for operations and PLM closed loop design may be orchestrated by the supervisory computer control 262 such that a digital thread connects design, manufacturing, and/or operations.

As used herein, the term “on-operation” may refer to an operational state in which a twinned physical system and the digital twin 250 are both operating. The term “off-operation” may refer to an operational state in which the twinned physical system is not in operation but the digital twin 250 continues to operate. The phrase “black box” may refer to a subsystem that may be comprised by the digital twin 250 for recording and preserving information acquired on-operation of the twinned physical system to be available for analysis off-operation of the twinned physical system. The phrase “tolerance envelope” may refer to the residual, or magnitude, by which a sensor's reading may depart from its predicted value without initiating other action such as an alarm or diagnostic routine. The term “tuning” may refer to an adjustment of the digital twin's software or component values or other parameters. The operational state may be either off-operation or on-operation. The term “mode” may refer to an allowable operational protocol for the digital twin 250 and its twinned physical system. There may be, according to some embodiments, a primary mode associated with a main mission and secondary modes.

Referring again to FIG. 2B, the inputs to the digital twin 250 may include conditions that include environmental data, such as weather-related quantities, and operational controls such as requirements for the twinned physical system to achieve specific operations as would be the case for example for aircraft controls. Inputs may also include data from sensors that are placed on and within the twinned physical system. The sensor suite embedded within the twinned physical system may provide an information bridge to the digital twin software. Other inputs may include tolerance envelopes (that specify time and magnitude regions that are acceptable regions of differences between actual sensor values and their predictions by the digital twin), maintenance inspection data, manufacturing design data, and/or hypothetical exogenous data (e.g., weather, fuel cost and defined scenarios such as candidate design, data assignment, and maintenance/or workscopes).

The outputs from the digital twin 250 may include a continually updated estimate of the twinned physical system's Remaining Useful Life (“RUL”). The RUL estimate at time=t is for input conditions up through time=t−τ where τ is the digital twin's update interval. The outputs might further include a continually updated estimate of the twinned physical system's efficiency. The BTU/kWHr or Thrust/specific fuel consumption estimate at time=t is for input conditions up through time=t−τ where τ is the digital twin's update interval. Other outputs from the digital twin 250 may include alerts of possible twinned physical system component malfunctions and the results of the digital twin's diagnostic efforts and/or performance estimates of key components within the twinned physical system. For example, with the digital twin 250, an operator might be able to see how key sections of a gas turbine are degrading in performance. This might be an important consideration for maintenance scheduling, optimal control, and other goals. According to some embodiments, information may be recorded and preserved in a black box respecting on-operation information of the twinned physical system for analysis off-operation of the twinned physical system.

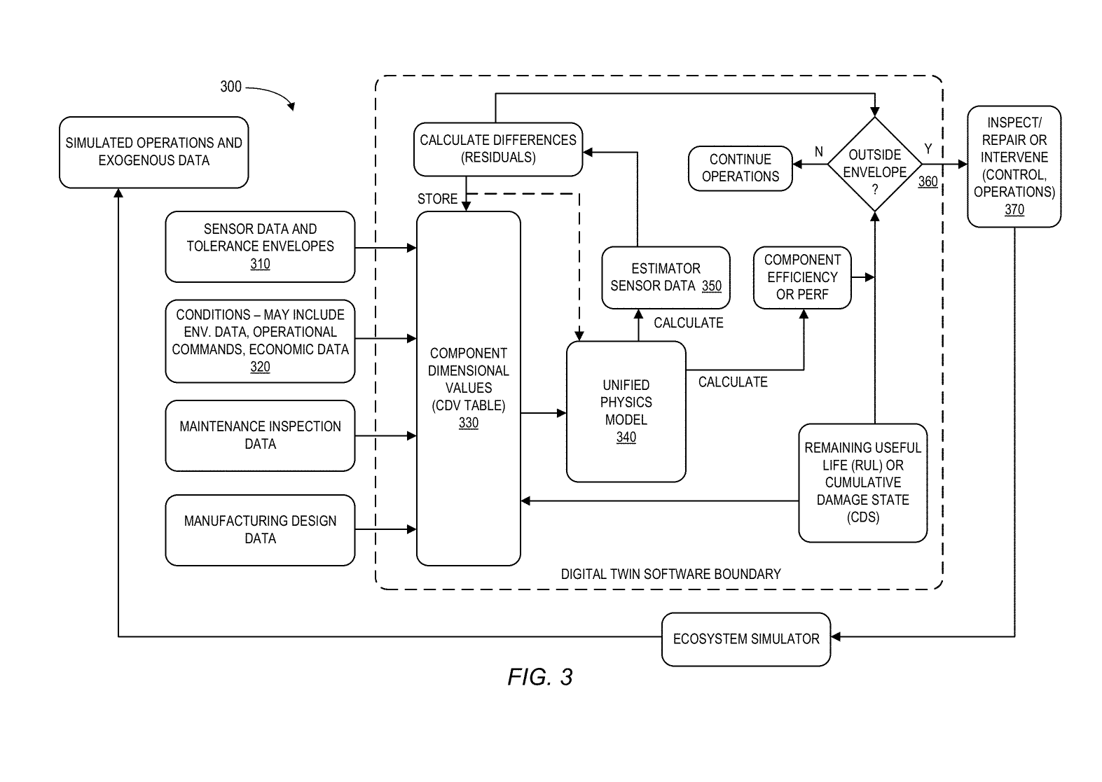

An example 300 of a digital twin's functions according to some embodiments is illustrated in FIG. 3. Sensor data and tolerance envelopes 310 from one or more sensors and conditions data 320, which includes operational commands, environmental data, economic data, etc., are continually entered into the digital twin software. A UPM 340 is driven by CDV values 330 (which may include maintenance inspection and/or manufacturing design data) and the conditions data 320. The sensor data 310 is compared to the expected sensor values 350 produced by the UPM 340. If differences between the sensor values at time=t and the UPM predictions fall outside of the tolerance envelopes, then a report issues at 360. The report 360 may state the occurrence of the exceedance and lists all of the components that have been previously identified and stored in the system structure of the digital twin. A report 360 recommendation 370 may indicate that the report 360 should be handled in different ways according to whether the digital twin is being examined off-line, at the conclusion of a mission for example, or whether the digital twin is operating on-line as it accompanies its twinned physical system and continually provides an estimate of the RUL (or a Cumulative Damage State (“CDS”)). The CDV table 330 may be updated by the sensor 310 and conditions 320 data at time=t+τ. The recommendation 370 (e.g., to inspect, repair, and/or intervene in connection with control operations) may be used to determined simulated operations exogenous data via an ecosystem simulator.

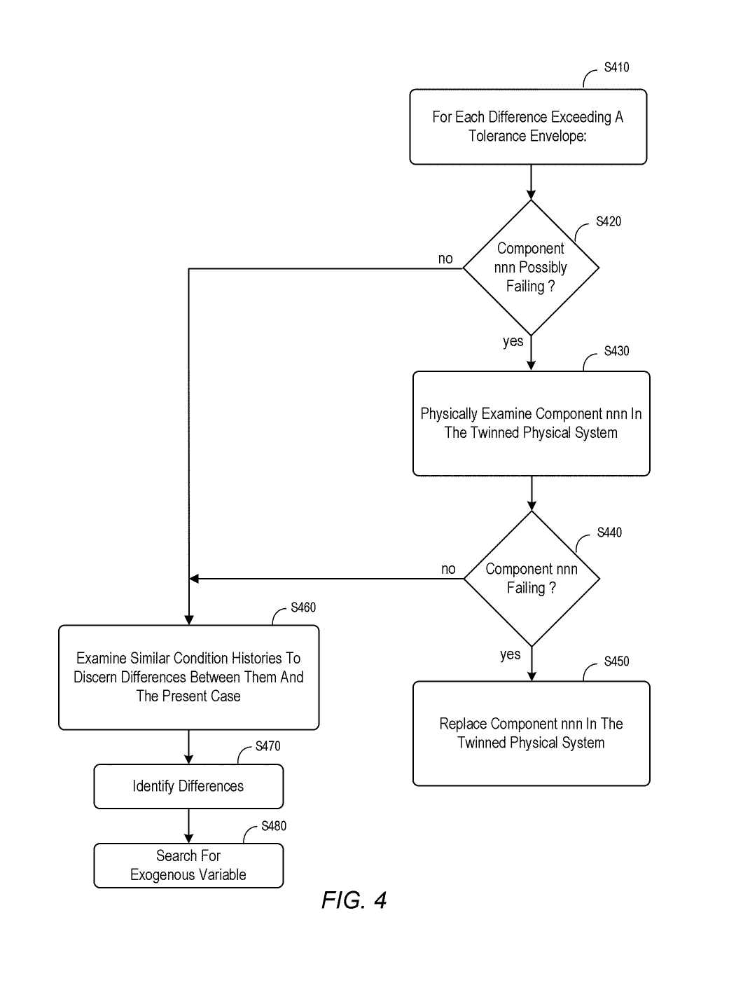

If a digital twin is examined off-line, the examination may progress as illustrated in FIG. 4. At S410, a start of an examination for each exceedance and candidate component may begin. Control passes to S420 where it is determined if the component nnn might have failed or be failing. Unless component nnn's potential failure is ruled out by other data, control passes to S430 wherein component nnn of the twinned physical system is physically examined. Control passes to S440 where the component's health has been determined upon physical inspection. If the component's health is inadequate, control passes to S450 where the component in the twinned physical system is replaced. If possible failure of component nnn has been ruled out in S420 (or the component was not failing at S440), control passes to S460 which orders an examination of previous and similar condition histories in an attempt to discern differences between previous similar condition histories and the present cases wherein an exceedance was reported. The differences are discerned in S470 and control passes to S480 which initiates a search for an exogenous variable, where, in this usage, an exogenous variable denotes an effect-causing factor not included in the system model.

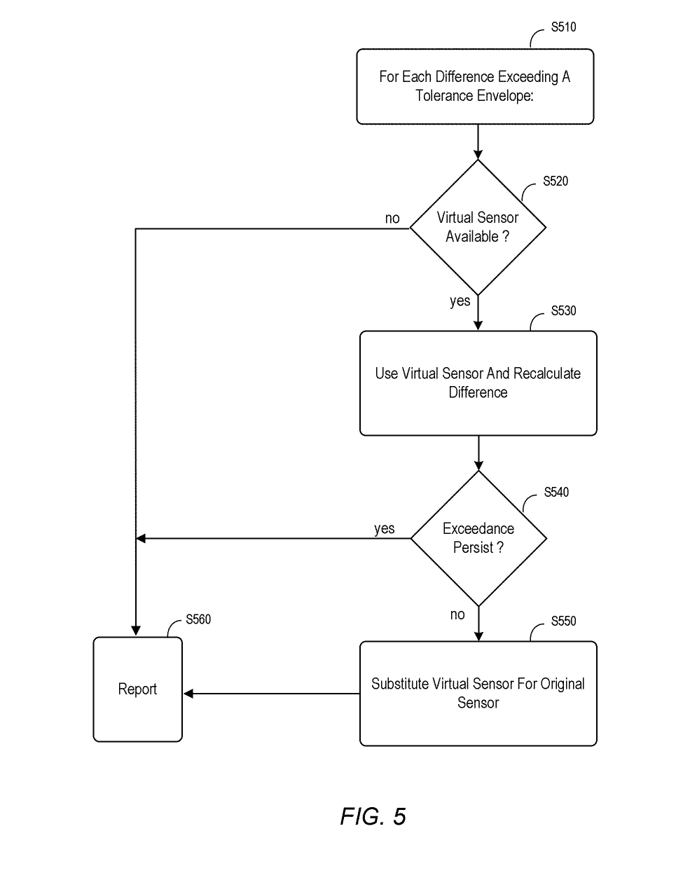

If the digital twin is operating on-line as it accompanies its twinned physical system and an exceedance is reported, then the procedure according to FIG. 5 may be followed beginning with S510. The decision block S520 determines if a virtual sensor is known by the system structure of the digital twin for the sensor whose value has led to the reporting of an exceedance. According to some embodiments, a virtual sensor may sense un-measurable parameters when there is no sensor available, or when a suitable sensor is impractical, or the sensor in use has failed. If a virtual sensor is available, block S530 instructs that it be tested to see if the exceedance persists upon its use at block S540. If the exceedance does not persist, then block S550 instructs that the virtual sensor replace the original sensor and a report be made. If the virtual sensor does not resolve the reported differencing (of if no virtual sensor was available at block S520), then block S560 directs that a report be made so that appropriate action may be taken.

Note that sensor failure might be detected in a variety of other ways. For example, a simple technique for a digital twin to diagnose a rapid and pronounced failure of a sensor is to calculate the maximum rate that a particular sensor reading could possibly change given the mission profile. A sensor whose rate exceeded this maximum would be declared failed, or at the very least, highly suspect. For cases wherein a sensor does not undergo a sudden and dramatic failure, diagnosis may be made through the use of a bank of Kalman filters. A Kalman filter may take in sensor readings and produce state variable estimates that can be used with a built-in plant model to generate sensor estimates. Such a bank of filters may comprise a plurality of filters each of which uses a different sensor suite. The first filter may, for example, use all but the first sensor as an input, the second filter may use all but the second sensor as an input, etc. In this way, each filter can test the hypothesis that the sensor it does not include is not operating properly. That is, when a sensor fails the output of every filter except one will be corrupted by incorrect information (indicating which sensor has in fact failed).

The report at block S560 may also utilize a Kalman filter bank is being applied to include actuator and component fault detection. This may accomplished, for example, by adding an additional Kalman filter that utilizes all sensors, and estimates several tuning parameters in addition to the state variables to account for model mismatch due to component or actuator faults. If the tuning parameter estimates become large while the residuals in the sensor fault hypothesis filters remain small, it may indicate that the fault is within a component or actuator.

According to some embodiments, a comprehensive monitoring envelope may be employed by a digital twin. Note that monitoring of a twinned physical system's components may start with their manufacture and proceed through transportation of those components and eventually through an assembly of the components in building the twinned physical system. Monitoring of the completed twinned physical system may be continuous, according to some embodiments, even during the twinned physical system's downtime.

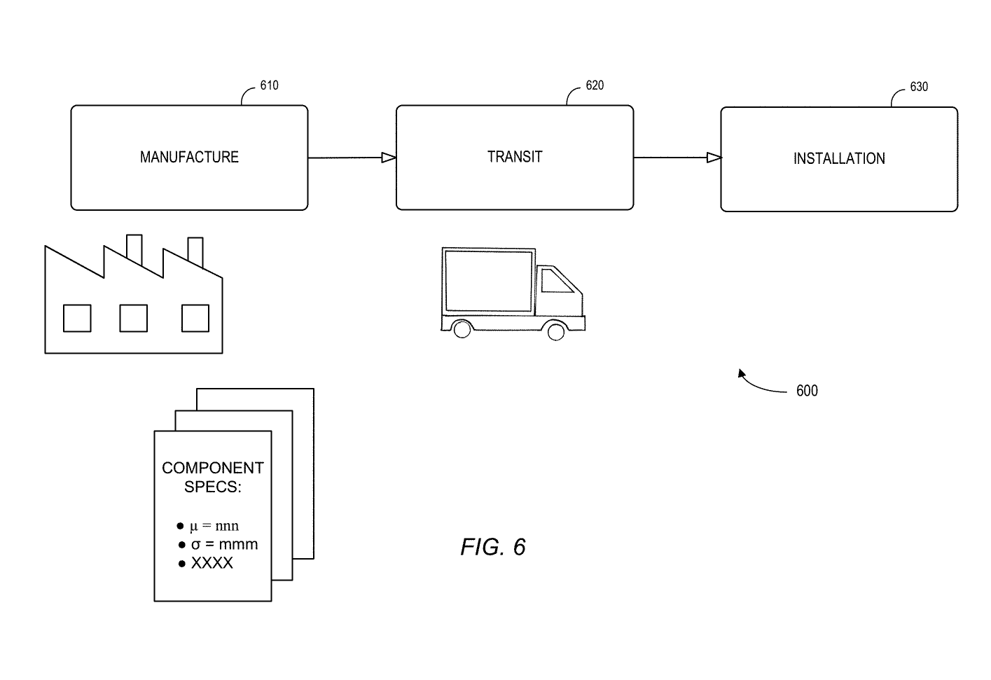

According to some embodiment, significant RUL affecting events may be detected and evaluated. This may include inculcating a supply chain sensitivity during the building of the digitally twinned physical system. For example, FIG. 6 illustrates 600 a span of a comprehensive monitoring envelope that follows system components from manufacture 610 through transportation (“transit”) 620 through installation 630. In manufacture 610, the system components may be produced using manufacturing techniques and practices that guarantee a narrow range on the plurality of system components produced in a manufacturing lot. The system components may then be transported to a user or owner for integration into a host system.

The transportation 620 of the system components can alter their RUL if conditions are encountered that exceed various limits such as, for example, temperature, shock, pressure, and/or humidity. The supply chain may require a system for collecting and analyzing shipment parameter data that affects the predicted statistical variables of the system components. Such a system may comprise a plurality of data collection subsystems for respectively collecting shipment parameter data encountered by respective articles being shipped, and a data analysis subsystem coupled to receive the collected shipment data for adjusting the respective predicted statistical variables of the articles. The data collected during the system component shipment may subsequently be entered into the digital twin.

Finally, the installation 630 of the system components may alter their expected RUL if the installation suffers misadventure such as, for example, rough handling, incorrect mounting, and/or excessive torque. One embodiment for guiding and monitoring the installation process (and collecting the information respecting any installation mishandling) is to provide an installer with a computer-instructed “wizard” with sensors attached to the installation tools and system components. The collected installation information may also be subsequently entered into the digital twin process.

In order to compute the RUL of a system, it may be necessary to know or assess the highly multi-dimensional state of the system. That the state of the system can change dramatically when the system is not in operation or not operating in its most stressful mode may at first seem counterintuitive. For example, an aircraft that is parked or taking on fuel, baggage, or passengers would not be expected to encounter as harsh an environment as during a flight portion.

Note that there may be cases where significant changes to, for example, an aircraft's health can occur during non-flight periods. For example, in at least one aircraft a pitch-up control cable was damaged when the controls were locked and the plane was parked when other aircraft taxied and blasted the parked plane. This caused a force between 0.2 and 2.8 times the limit load on the pitch-up cable. In this case, even a single exposure was thought to be enough to break the cable. Another example may be associated with low speed collisions of a parked aircraft with a ground service equipment vehicle (such as a baggage delivery vehicle or a fuel truck). Ground service equipment interactions are responsible for most of the damage to commercial transport aircraft and it is estimated that half of the damage is due to collisions with baggage vehicles. These collisions are blunt impacts and may affect a significant area (involve multiple elements hidden within the structure). Such collisions might leave no more than minimal visual signs of damage yet may still be deleterious to both aluminum and carbon-epoxy composite materials. Appropriate sensors might be deployed and monitor the system, in this example an aircraft, during periods of inactivity and incidents of potential damage may be noted and reported to the digital twin software.

Putting sensors, and even intelligence, into basic parts may expand the number of dimensions of any particular system so that no two systems will stay strictly identical as they age through different operational, control transient, and/or environmental conditions. The dimensions that significantly affect a particular component (and should therefore be tracked) during the component's life may be initially estimated by best engineering judgment and can be augmented or refined as more is learned about a particular component's behavior under different operational and/or environmental conditions. For example, an automobile has many components that are tracked by insurers in warranty programs. One of these components is the Interior Climate and Comfort (“ICC”) system. This system includes a compressor, compressor mounting bracket, clutch and pulley, orifice tube, condenser, heater core, heater control valve, receiver/dryer, evaporator, air duct and outlets, accumulator, air conditioning temperature control program, and seals and gaskets. It may be intuitive that the ICC system will be sensitive to environmental temperature.

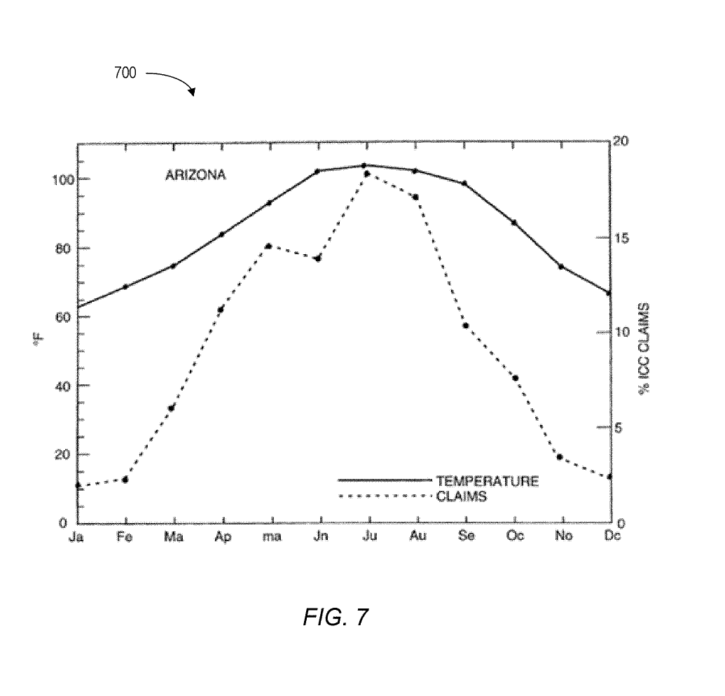

A study of the claims of a particular auto dealer warranty service upholds this intuition. FIG. 7 displays a plot 700 of both the normal monthly maximum daily temperature at a particular airport and the claim percentages of the cars under warranty versus month for that geographic area within the United States. The two variables have a linear correlation coefficient of equal to 0.939. If a digital twin were created for an ICC system, the dimensions of the stored operational and environmental data would include a history of the particular ICC system's temperature history.

There may be other, exogenous, variables that are not initially identified that meaningfully impact a component or system's health. Continuing with the example of the ICC system, considering all of the claims across the United States (using a major city in each state), a regression analysis may be performed using environmental data that includes the maximum of average monthly maximum temperature (Tₘₐₓ), the minimum of the average monthly minimum temperature (Tₘᵢₙ), the yearly average Snow and Sleet (“S&S”) accumulation in inches, the average Relative Humidity (“RH”) percentage near mid-day, the normal Degree Days (“DD”), the yearly average total precipitation in inches (“Precip”), average number of days in year for which the minimum temperature is below freezing (“F), and the elevation above sea level in feet (“E”).

Suitable techniques of multivariate linear regression may be applied and the dependent variables of interest can be fitted to a subset of the aforementioned eight environmental variables (i.e., Tₘₐₓ, Tₘᵢₙ, S&S, RH, DD, Precip, F, and E). An equation may be derived by successive weighted least square refinements by excluding independent environmental variables with p-values that are no greater than 0.01. (The p-value in the regression analysis may represent the probability that the coefficient has no effect.) The resulting equation for the average number of claims for ICC per policy contract C, is:

C=−1.60+0.0135Tₘₐₓ+0.0116Tₘᵢₙ+0.00432RH+0.00369S&S

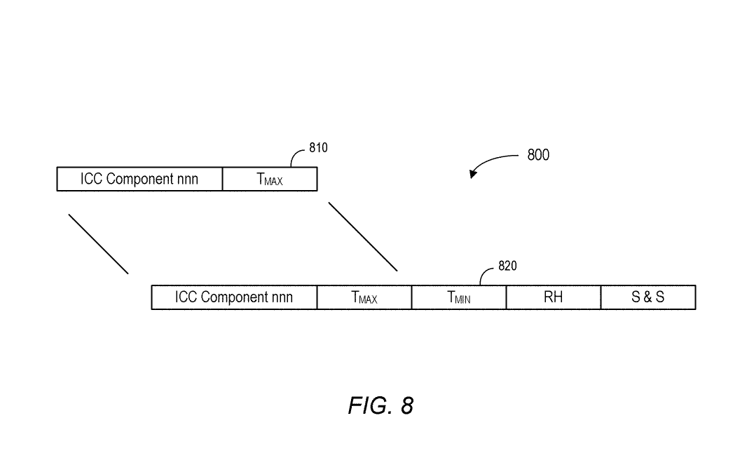

revealing important exogenous variables that aid the accuracy of the ICC component's health. FIG. 8 illustrates 800 the dimensional expansion of the component dimensions for the ICC components. Before the regression analysis disclosing that Tₘᵢₙ, RH, and S&S were significant variables as well as Tₘₐₓ, the component dimensional values stored for the ICC components included only the single dimension for Tₘₐₓ 810. After the regression analysis, the component dimensional values stored for the ICC components may be expanded to include the exogenous variables Tₘᵢₙ, RH, and S&S 820.

Pictures, especially moving pictures, may instill greater insight for a technical observer as compared to what can be determined from presentations of arrays or a time series of numerical values. A structural engineer or a thermodynamics expert may often gain a deep insight into problems by observing the nature of component flexions or the development of heat gradients across components and their connections to other components.

For this reason, a Graphical Interface Engine (“GIE”) may be included in a digital twin. The GIE may let an operator select components of the twinned physical system that are specified in the digital twin's system structure and display renderings of the selected components scaled to fit a monitor's display. The GIE may also animate the renderings as the digital twin simulates a mission and display the renderings with an overlaid color (or texture) map whose colors (or textures) correspond to ranges of selected variables comprising flexing displacement, stress, strain, temperature, etc.

The GIE may also be used in engineering design by allowing changes to be posited to values of components within CDV table, such as material composition and dimensional values (e.g., a thickness value). Changes to linkage structures, joints and bearings, and/or variations of shape may also be posited to determine numerically and visually how the substitutions would function under a particular mission.

The GIE may, for example, be used to explore the question of sensor sufficiency. Generally, there may be fewer sensors incorporated in a vehicle than health parameters to be directly measured. Often, Kalman filters are used to estimate health parameters that are not directly measured by a dedicated sensor. But even though Kalman filtering seems to result in what appears to be good estimates from the outputs that are directly monitored, in the sense that the health parameter estimates can accurately recreate the directly monitored outputs, this might not guarantee an accurate estimation. The GIE may be used to devise and locate a potential additional sensor within the vehicle that will more directly measure a health parameter that other would otherwise be virtually and potentially inaccurately inferred by other sensors.

A digital twin may comprise a code object and its productive activity may be associated with computation. Effective computation may depend upon the computational structure provided, which may be central or dispersed, serial or parallel, and might be motivated at least in part by the communications structure that governs the delivery parameters of its sensor data to computing elements, the computer-to-computer channel time-bandwidth properties, and/or the interrupt protocols placed on disparate computing elements for parallel or concurrent computation.

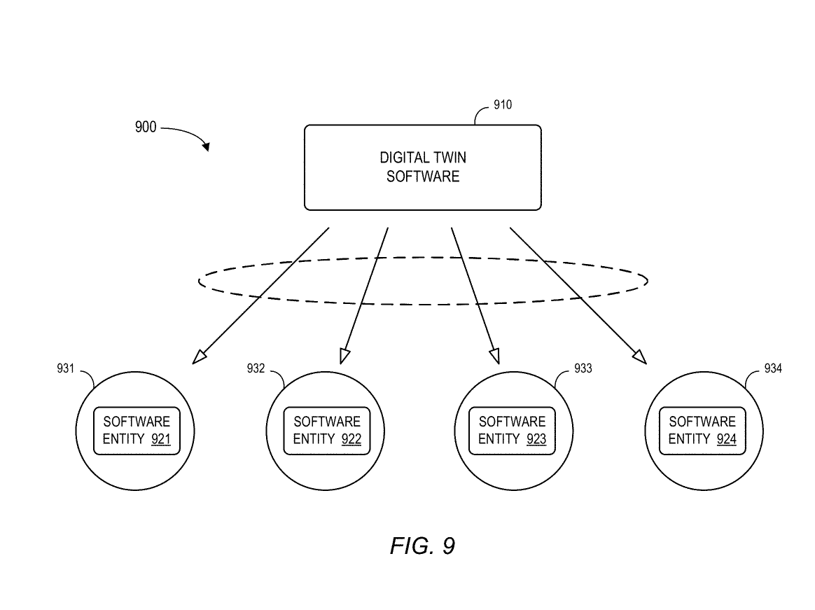

A digital twin may be run at a single location or may be distributed on or over a twinned physical system. One advantage of the latter instantiation may be an enhanced proximity of sensor computations to the sensors themselves. In one embodiment, a digital twin's codes and computations may be partitioned into a plurality of spatially separated units as illustrated by the system 900 in FIG. 9. The digital twin software 910 may be maintained in a data warehouse (not shown in FIG. 9). For this example, as indicated by 915, the digital twin software 910 may be partitioned into a set of software entities 921, 922, 923, 924. Each of these software entities 921, 922, 923, 924 may be hosted by a Computational Associate (“CA”). In this example, the software entities 921, 922, 923, 924 are respectively hosted by CAs 931, 932, 933, 934. The distribution of the software entities 921, 922, 923, 924 may be distributed to their respective CA 931, 932, 933, 934 hosts using a Data Transportation Network (“DTN”) that may be a private enterprise data network or a public network, such as the Internet of Things (IoT). Each CA 931, 932, 933, 934 may comprise a module with a structure for providing local data storage, performing computation, and/or serving as a gateway to the DTN for communications relating to the individual components of the modeled physical system.

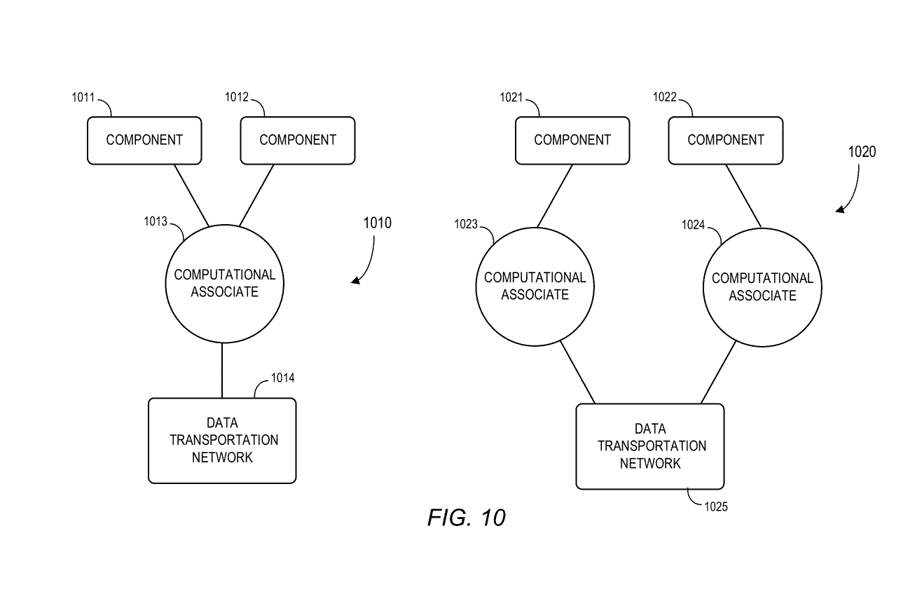

Note that there may be different configurations possible to connect components, such as sensors, to each CA 931, 932, 933, 934. For example FIG. 10 illustrates a configuration 1010 in which two components 1011, 1012 are both connected to a CA 1013 which in turn is connected to a DTN 1014. This configuration might be used, for example, if the components 1011, 1012 are spatially proximate to each other on the physical system. In another configuration 1020, two components 1021, 1022 may each be connected to a different CA 1023, 1024. Moreover, each CA 1023, 1024 may be connected to a single DTN 1025. This configuration might be appropriate, for example, if the components 1023, 1024 are significantly spatially distant from each other on the physical system.

In the example where the components 1011, 1012 the CA 1013 are in spatial proximity, the communication links between the components 1011. 1012 and the CA 1013 might comprise physical layer links (as opposed to virtual connections). The individual links may be, for example, wired or wireless links. The CA 1013 may also be in communication with the DTN 1014 which may be capable of sending and receiving data from other subscribers to the DTN (such as a data warehouse not shown in FIG. 10). This example might be representative of modeling appropriate for an asset with a limited spatial extent, such as a jet engine.

In other cases, components of an asset might not be n spatial proximity and communication between them may take place through a DTN. For example, as illustrated in FIG. 10, two system components, 1021, 1022 are not in spatial proximity and each sends information to a CA 1023, 1024. For example, one component 1021 may have a physical layer link with CA 1023 while the other component 1022 is in communication with that CA 1023 through a physical layer link with the other CA 1024 (which in turns communicates with CA 1023 via the DTN 1025). This example might be representative of modeling an asset, such as a series of significantly physically separated compressor stations associated with a natural gas pipeline.

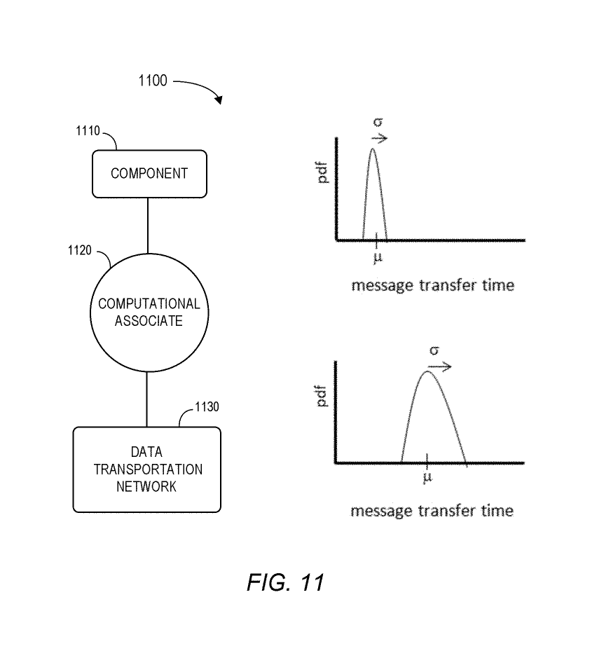

When running code in a CA that requires inputs from components that are not in spatial proximity, or when data or code is requested of, and transported from, a data warehouse, the system may experience longer communication latencies and/or increased variations in those latencies. As illustrated in FIG. 11, a component 1110 communicates over a physical layer link with a CA 1120. The message transfer times may have a Probability Density Function (“PDF”) with mean and standard deviation values as illustrated by the upper graph in FIG. 11. When the CA 1120 requests data or code through a remote entity connected to a DTN 1130, the communication latencies and their variations are expected to be larger than those experienced over the physical layer link between the component 1110 and the CA 1120 as illustrated by the lower graph in FIG. 11.

Providing appropriate communications security for the different communication paths may be important to preserve the confidentiality of data and protect against adversarial measures (such as message alteration and/or message spoofing). The examples described herein have illustrated three different classes of communication, each associated with different assessments to determine appropriate data security. In order of increased complexity, the three classes are: (1) communications between a component to a CA via a physical layer link (such as the communications link between the component 1011 and the CA 1013 illustrated in FIG. 10; communications between a first CA and a second CA through the DTN (such as the communications path between the CA 1023 and the CA 1024 illustrated in FIG. 10); and (3) communications between a CA and a company-external facility such as a data warehouse.

For class (1) communications, encryption might not be required when the communications link is a wired connection. If wireless, encryption may be appropriate if there is the potential of passive monitoring for an adversary's gain or the potential of active adversarial measures (such as message alteration or message spoofing). If encryption is appropriate, it may be straightforwardly provided by a private (symmetric) key system such as the Advanced Encryption Standard (“AES”) or a proprietary algorithm.

For class (2) communications, encryption may be appropriate if the data will pass outside of an enterprise perimeter (e.g., when it is carried on the IoT). In this case, encryption may be straightforwardly provided by a private (symmetric) key system such as AES or a proprietary algorithm.

For class (3) communications, there may be a need to securely interface with an enterprise-external entity such as a data warehouse, which most likely serves many different external customers. Communications between a CA and the enterprise-external entity may pass over a public data transportation network such as the IoT, and encryption may therefore be appropriate. One suitable encryption scheme that may be straightforwardly implemented by both the CA and the enterprise-external entity is built on a public (asymmetric) key cryptographic algorithm that develops keys by use of a digital certificate scheme, a well-known technique in the art.

The structure of a CA may include one or more wired circuit communication ports for receiving and transmitting messages containing data, such as physical system modeling code, addresses of CA's hosted components, recent values produced by components, requests for such data, and/or the reporting of physical system modeling. The structure of the CA may further include one or more wireless circuit communication ports for receiving and transmitting messages containing data, such as physical system modeling code, addresses of CA's hosted components, recent values produced by components, requests for such data, and/or the reporting of physical system modeling. Other elements of a CA structure might include: a real-time clock; a computer for running physical system model code, processing and routing messages, and/or executing software cryptographic functions; and electronic hardware for executing cryptographic functions. Still other elements of a CA might include: a random (as opposed to a pseudorandom) number generator for use in cryptographic operations and/or executing some physical system model code; and memory for storing tables of data for communications management, physical system model code, and/or data respecting physical system componentry (e.g., manufacturing specifications and/or individual component functional histories)

Because the CA may reside and function in a stressed environment, it may be prudent to have an electronics odometer to assess the health of the electronic componentry used within the CA itself to accurately predict its RUL. Note that electronics failure may result through many different mechanisms, including bias temperature instability, hot carrier injection, time-dependent dielectric breakdown, and/or electro-migration (especially as device layouts get smaller and the operational voltage margins diminish). A relatively small amount of chip surface and power may be dedicated to hosting circuitries that can be used to assess the wear and tear of the foregoing and other failure-promoting mechanisms. The odometer might comprise an on-chip, in-situ monitor, with predictive algorithms incorporated for using the multi-dimensional data gathered by the monitoring circuitries.

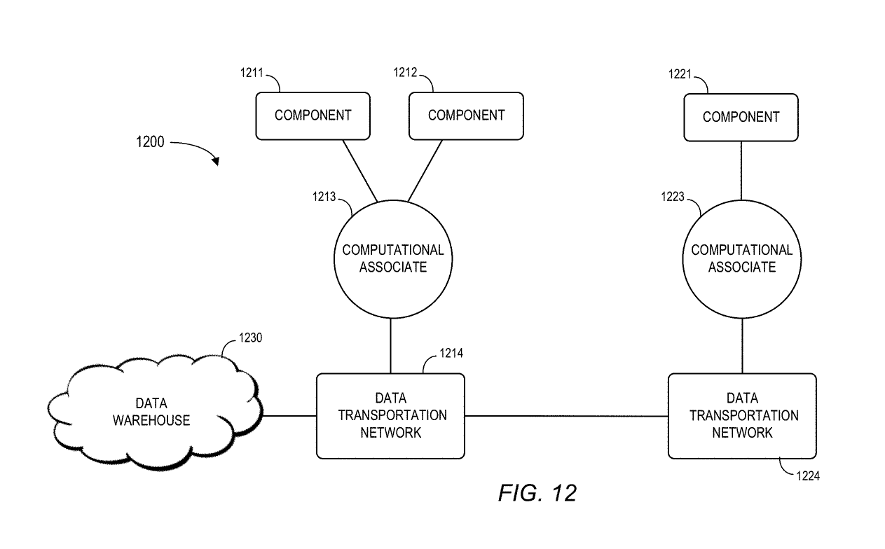

FIG. 12 illustrates a non-limiting example 1200 layout of entities involved in physical system modeling. In this example 1200, a CA 1213 receives data from components 1211, 1212 and is designated to model physical system #N. The instruction to model may initiate the following successive modes and their actions: an activation mode; an instruction mode, a data connection mode, and a process mode.

In the activation mode, CA 1213 may create its physical layer link connection table populated by the IPv6 addresses of those components to which CA 1213 is connected by a physical layer link and the nature of the physical layer link (i.e., wired or wireless). In the example of Table I, the component number is provided in parenthesis after the component's IPv6 address for the reader's ease in following FIG. 12. Additionally, the IPv6 addresses may be shortened. Long strings of zeros, for example, may be compressed or suppressed by convention.

TABLE I
Component's IPv6 Address and Type of Connection to Hosting CA

| Component's IPv6 Address | Type of Physical Link Layer Connection |
|---|---|
| xx . . . x (element 1211) | wired |
| xx . . . x (element 1212) | wireless |
| xx . . . x (element 1213) | wired |

In the instruction mode, after CA 1213 is tasked with modeling physical system #N: (1) CA 1213 may request and receive model code for physical system #N from the data warehouse 1230; and (2) CA 1213 may be provided with the IPv6 addresses to be used for the component variables in the model code for physical system #N.

In the data connection mode, CA 1213 may launch discovery messages into the DTN 1214 to find those CA's that have physical layer links to the components to which CA 1213 does not have physical layer link connections. For this example, CA 1223 may report having a physical layer link to component 1221. CA 1213 may be guided by instructions in the model code for physical system #N and request that CA 1223 forward to CA 1213 time-stamped values from component 1221 at a specified rate. If component 1221 is a sensor, for example, the specified rate may be governed by the Nyquist criterion. Optionally, CA 1213 may measure μ and σ of the latencies in delivery to CA 1213 of the time-stamped values forwarded by CA 1223. In the process mode, CA 1213 may then proceed to model physical system #N.

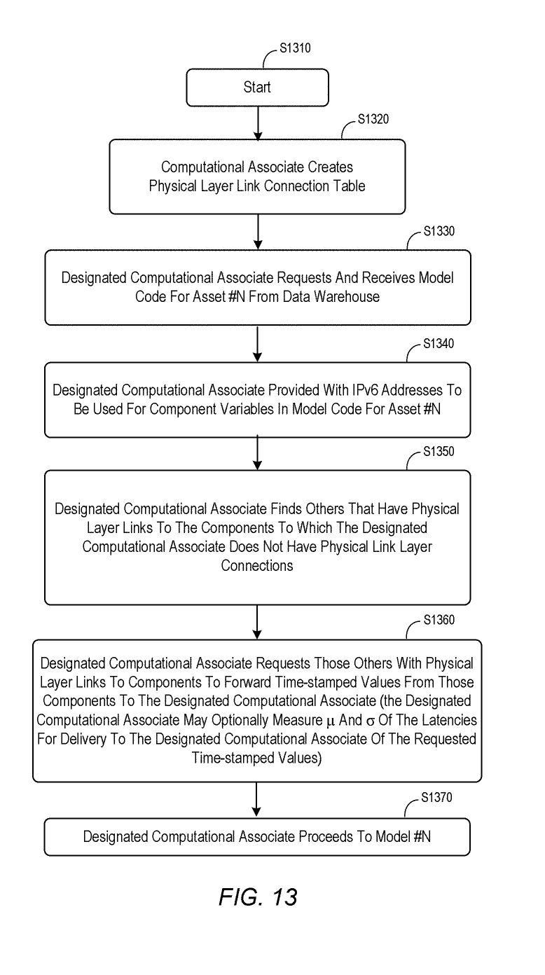

A flow chart of the sequencing of steps in the preceding example of the designated CA modeling is illustrated in FIG. 13. In particular, the modeling flow may be initiated at S1310. At S1320, the CA may create a physical layer link connection table. At S1330, the designated CA may request and receive the model code for asset #N from the data warehouse. At S1340, the designated CA may be provided with the IPv6 addresses to be used for the component variables in the model code for asset #N. At S1350, the designated CA finds those CA's that have physical layer links to the components to which the designated CA does not have physical link layer connections. At S1360, the designated CA requests those CA's having physical layer links to components which the designated CA does not have physical link layer connections, to forward time-stamped values from those components to the designated CA. The designated CA may optionally measure μ and σ of the latencies for delivery to the designated CA of the requested time-stamped values. At S1370, the designated CA may proceed to model asset #N.

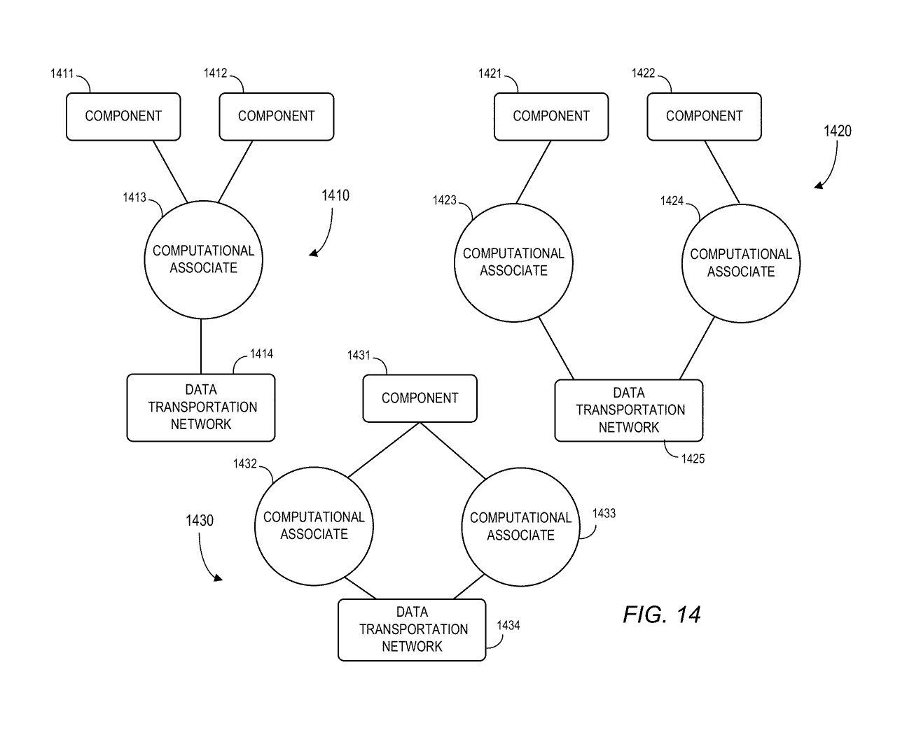

Note that many different configurations may be used to connect components to a CA. For example, FIG. 14 illustrates some of these configurations. In one configuration 1410, two components 1411, 1412 are both connected to a single CA 1413 which in turn is connected to a DTN 1414. This configuration 1410 might be used if the components 1411, 1412 are spatially proximate on the physical system. In another configuration 1420, two components 1421, 1422, are each connected to a different CA 1423, 1424. Each CA 1423, 1424 is connected to a single DTN 1425. This configuration 1420 might be appropriate, for example, if the components 1423, 1424 are significantly spatially distant from each other on the physical system. In still another configuration 1430, a single component 1431 is connected to two CAs 1432, 1433, each of which are connected to a single DTN 1434. This configuration 1430 might be used, for example, when the component 1431 provides data that is promptly needed by computations taking place in both of the CAs 1432, 1433. This configuration 1430 might also be appropriate when component 1431 is substantially important to digital twin calculations and, by virtue of the redundancy imparted by the configuration 1430, a data path to 1431 will still exist upon failure of either of the two CAs 1432, 1433.

Having a set of CAs connected via a DTN may allow for distributed computation and benefit from the computational gain provided by having more than a single computational platform present in a CA. Note that communication between two CAs through the DTN may be subject to varying latency and might be of lower bandwidth than communications provided by a physical layer link between two CAs. This characteristic of the communications supporting the digital twin computations may result in a departure from a classical view of parallel computation as summarized in Table II. Moreover, this characteristic may be recognized and accounted for when performing digital twin computations which are distributed and not strictly parallel.

TABLE II
Significant Differences: Parallel Computation and
Distributed Computation

| Parallel Computation | Distributed Computation |
|---|---|
| Processors located in a spatial cluster | Processors dispersed |
| Processor inter-communications low | Processor communications |
| latency | higher latency |
| Processor inter-communications stable | Processor inter-communications |
| latency | variable latency |
| Processor inter-communications high | Processor inter-communications |
| bandwidth | lower bandwidth |

Note that computation times needed to solve exact equations may exceed the time required for a result in order to monitor, protect, and/or effectively prognosticate concerning a twinned physical system. For this reason, it may be desirable to use computational approximations by employing such techniques as linearization, reduced order modeling, fuzzy logic, and/or neural networks.

In the case of linearization, many different scales may be applied to approximate physics-based models for small departures from previously studied conditions. Moreover, it might be used in a much broader application scale of modeling—such as, for example, in decomposing Kalman filter operations into piecewise linear segments for faster-than-real-time processing of sensed engine measurements.

In the case of Reduced Order Modeling (“ROM”), software for evaluating damage and predicting RUL or the time to failure of a twinned physical system may be formed by appropriate extractions from full digital twin code. These extractions may in turn be reduced in complexity by approximations. An additional approach in using a ROM digital twin is to use a discrete event simulation approach and essentially adjust the granularity of the time increments used in running the models. A corporate memory of modeling, such as might be stored in a data warehouse, may retain significant time stretches of the identical modeled system's behavior with conditions close to a present model's conditions. In this case, extrapolation approximations over significantly long time periods may be used instead of re-doing nearly identical computations. Alternatively, cached scenario results from prior runs may be called rather than re-calculated.

For example, ground-based gas turbines may benefit from ROM because combustion systems exhibit significant dynamics pertaining to unsteady pressure with oscillations fed by heat release which are, in turn, products of gas flow and chemistry. Such systems may require constant tuning. Moreover, tuning for high dynamic incidents cannot be done manually, and that is why computerized models may be used perform the tuning in a timely manner. Note that active control modifying combustion system dynamics has in many cases been successfully accomplished using reduced order models that are executable relatively quickly.

Models may not be completely physics based, but instead represent reduced or surrogate models which are trained by simulating “what-if” scenarios with a design of experiments. Multiple surrogate models in combination with physics based models may be orchestrated for scenario analysis and/or decision support. In instances where the computation time exceeds the requisite decision time constant, lesser fidelity or surrogate models may be selectively called to reduce the calculation sequence duration.

In some cases, ROM techniques may be required to estimate a RUL for an onboard platform if the RUL model is beyond the capabilities of the onboard computational hardware. The ROM of a Digital Twin (“ROMDT”) may an approximation of the ideal digital twin and the approximations may represent the physical models, their integration, and/or the complete state spaces of the components. Declarative programming may be used to implement a ROMDT following the paradigm of instructing the computer as to what is desired without specifically dictating the control flow for accomplishing the computations, such as the decision paths, within the ROMDT.

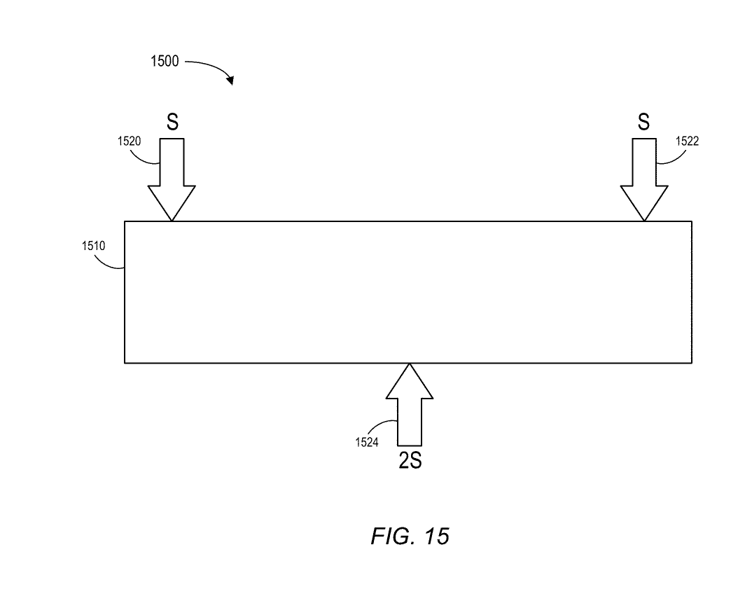

In the case of fuzzy logic, a ROM digital twin may be formed, according to some embodiments, using an analysis of material fatigue, and may substantially simplify computational complexity and/or provide for faster execution time. Even though uncertainty may exist in present models, fatigue problems may be especially well suited for the use of fuzzy logic. As an example, FIG. 15 illustrates 1500 a rigid member 1510 which may represent, for example, an aircraft longeron. The member 1510 may be at rest and subject to three forces. Two forces 1520, 1522, each of strength S, may be applied symmetrically about the center of member 1510, and these forces are balanced by a force 1524 of strength 2S applied in an opposite direction at the center of member 1510.

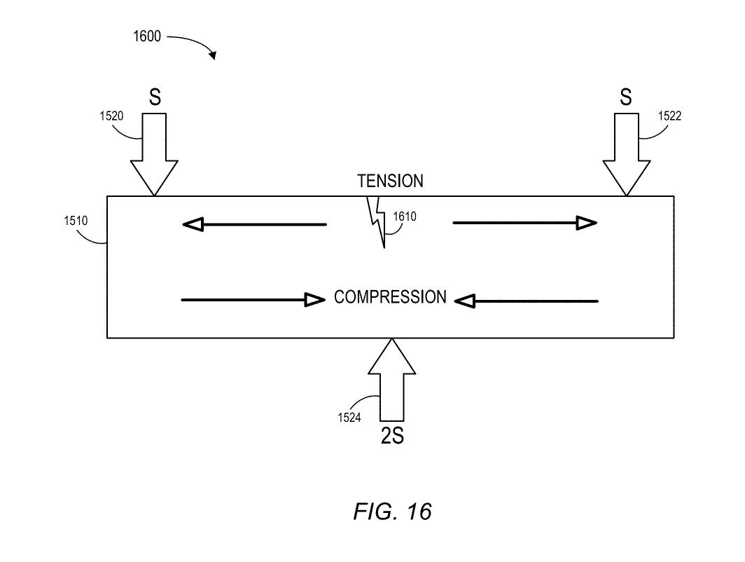

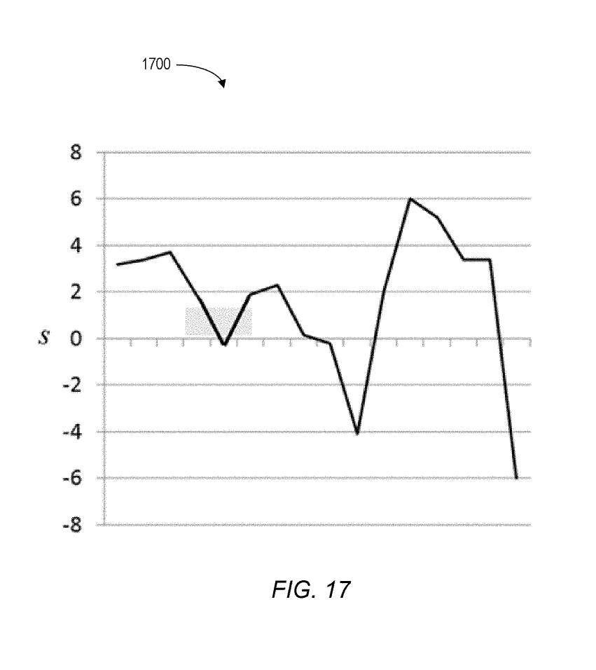

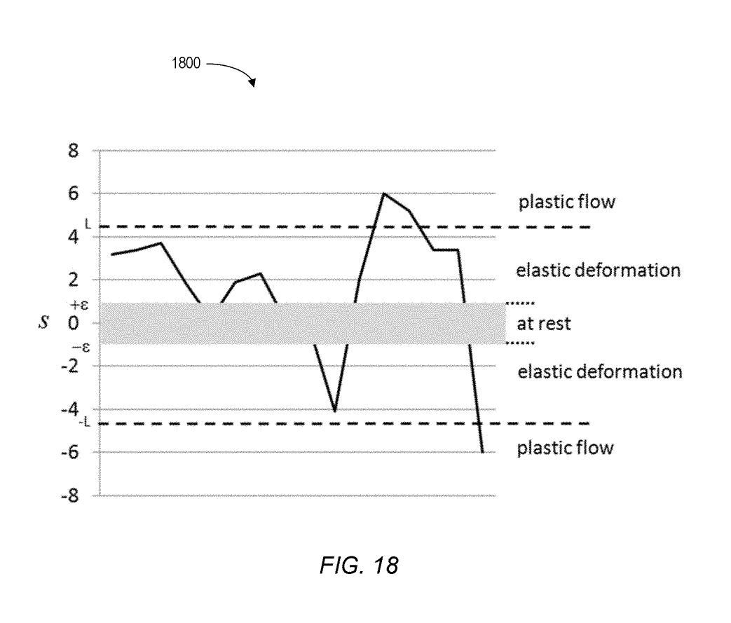

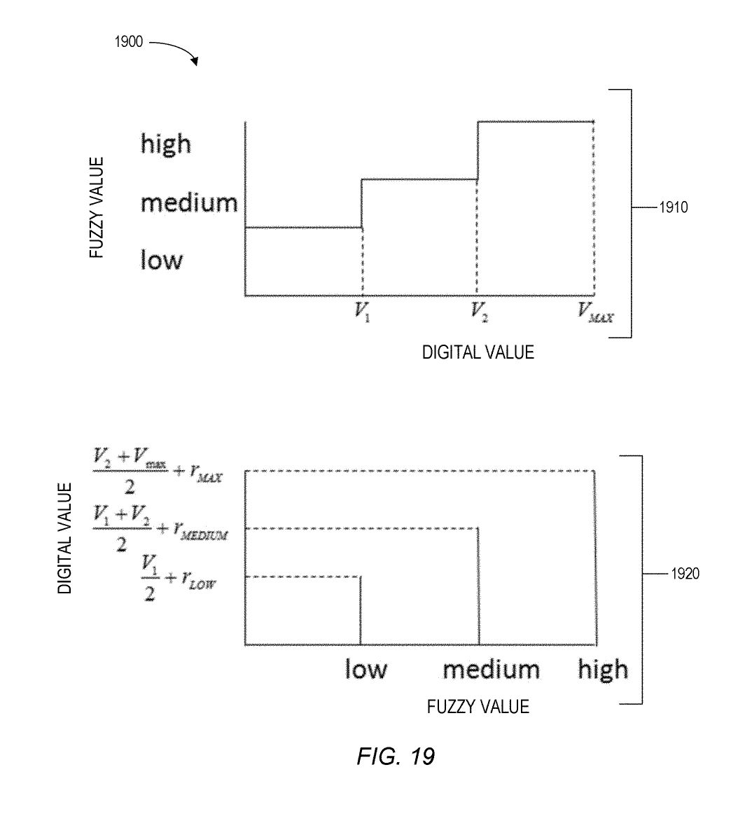

FIG. 16 illustrates a crack 1610 developing in the member 1510 as a result of excessive tension or repeated flexing (e.g., in connection with variations of the applied forces 1520, 1522, 1524). The crack 1610 does not need exceedance of the plastic flow threshold to form, and a great number of flexing cycles may be sufficient for the damage to start. FIG. 17 illustrates a time sequence 1700 of sixteen values of the force “S” {3.2, 3.4, 2.7, 1.8, −0.1, 1.9, 2.3, 0.15, −0.2, −4.1, 2.0, 6, 5.2, 3.4, 3.4, −6}. If a flexion is defined as having occurred in a sequence of values whenever “S” changes sign. The number of flexions exhibited by the data in FIG. 17 is therefore five. Note that the first two flexions may be an artifact of a sensor because the value of S is substantially close to zero. To more accurately count significant flexions, the system may first approximate the sixteen consecutive values of S by replacing the individual values by their signed integer magnitudes denoted by Q[S]. In this example, Q[S]={3, 3, 2, 1, 0, 1, 2, 0, 0, −4, 2, 6, 5, 3, 3, −6}. Next, the system might divide the regions of Q[S] as illustrated 1800 in FIG. 18 and plot the values of Q[S]. This technique represents a form of fuzzy characterization and may let the system discount extremely low amplitude flexions (and yet still count higher amplitude ones and also note when deforming plastic flow has been induced). A ROM digital twin may use computations that go back and forth between a digital representation and a fuzzy representation. An example of a bridge between the two representations is illustrated 1900 in FIG. 19. The conversion of a digital value to a fuzzy value is shown in 1910. In this example, digital values between zero and V_{MAX} are converted into one of the three fuzzy values {low, medium, high}. The conversion of a fuzzy value to a digital value is shown in 1920. Here, the three fuzzy values {low, medium, high} are respectively converted to the three digital values

$$\{ \frac{{V}_{1}}{2} + {r}_{LOW ,} \frac{{V}_{1} + {V}_{2}}{2} + {r}_{MEDIUM} , \frac{{V}_{2} + {V}_{MAX}}{2} + {r}_{MAX} \}$$

where LOW MEDIUM {r_{LOW}, r_{MEDIUM}, r_{MAX}} are three values of random variables with assigned means and distributions. According to some embodiments, true random variables may be available to a CA.

Neural networks, such as auto-associative neural networks, may be useful for condition monitoring by estimating sensed values of an operating condition, determining a residual vector between the estimated sensed values and the actual values, and performing a fault diagnostic on the residual vector. The auto-associative neural networks may comprise hidden nodes having nonlinear tan-sigmoid functions and a central bottleneck layer with embedded linear transformation functions.

Note that a “continually tuned digital twin” may refer to a digital twin that is continually updated as its twinned physical system is on-operation. At any particular instant, a continually tuned digital twin may host a faithful representation of the twinned physical system's current state with the result that the output of the continually tuned digital twin model may be expected to change with every fuel burn hour or airplane flight.

A gas turbine engine may be associated with a typically twinned physical system that needs periodic and also constant tuning. For example, ground based turbines may be tuned on schedule twice a year, prior to the summer and winter seasons, as weather may affect flame stability, carbon monoxide emissions, combustor dynamics, and/or nitrous oxide emissions. Tuning may be indicated not just for significantly different temperature regimes but also so that the turbine's operation will be compliant with new (e.g., more stringent) emissions regulations.

A continually tuned digital twin may comprise a method and technique for diagnosing and compensating for a single fault in a twinned physical system. The methods may be specified in code and controlled by code located within the continually tuned digital twin's system structure and/or supervisory computer control.

Note that modern gas turbine engines may include a plurality of sensors to monitor engine operation. A sensor suite for a turbine engine may include, for example, a fan inlet temperature sensor, a compressor inlet total pressure sensor, a fan discharge static pressure sensor, a compressor discharge static pressure sensor, an exhaust duct static pressure sensor, an exhaust liner static pressure sensor, a flame detector, an Exhaust Gas Temperature (“EGT”) sensor, a compressor discharge temperature sensor, a compressor inlet temperature sensor, a fan speed (N1) sensor, and/or a core speed (N2) sensor. A typical EGT sensor may, for example, use a thermocouple although other sensor techniques have been introduced such as pyrometry.

Because EGT may be an important element of information associated with engine condition monitoring, it may be desirable to estimate the EGT even when the EGT sensor fails or appears unreliable. A continually tuned digital twin might do this by: (1) detecting EGT sensor failure or unreliability; and (2) using a virtual sensing method to estimate EGT. Because it is important to have an accurate estimate of EGT, the continually tuned digital twin may estimate EGT in a way that minimizes noise and inaccuracy. Minimizing noise and promoting stability in the virtual estimation of EGT might be achieved, according to some embodiments, by assessing and blending or weighting outputs from a plurality of engine models.

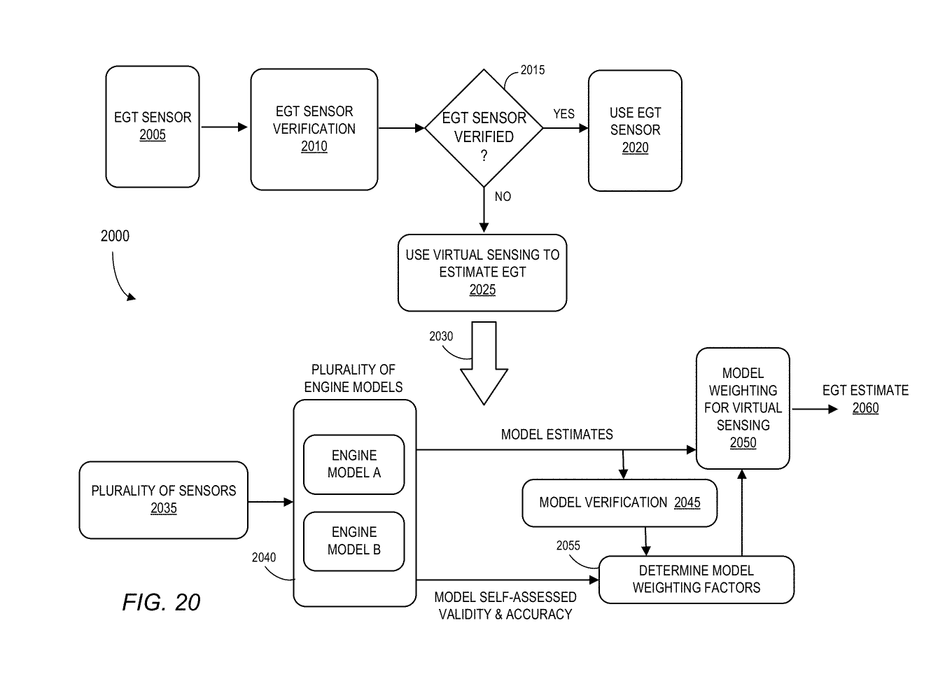

For example, FIG. 20 illustrates 2000 a method and system for detection of sensor incompetence and virtual sensing. In particular, EGT sensor values may be produced by an EGT sensor 2005 and EGT sensor verification may be performed at 2010. Verification may be a statistical test 2015 that assesses reported EGT values that depart from normal range limits or no longer correlate well with operational controls. If the EGT sensor is verified as operating properly at 2015, then the EGT sensor value is to continue to be used as the EGT value at 2020. If the EGT sensor is not verified as operating properly at 2015, the EGT value will be estimated by the virtual system 2025 and technique 2030. For the virtual system, a plurality of sensors 2035 are sampled whose values can collectively be jointly processed to estimate the EGT. This plurality of sensor values 2035 is input at 2040 which includes a plurality of engine models. For example, the models may comprise a high fidelity thermo/physics propulsion system model with adaptive learning including using actual current measured state information of the propulsion system to fine tune the physics equations of the engine model, a regression-fit model or database estimator, and/or a simplified physics-based table-based model.

For this non-limiting example, two models A and B are shown at 2040. The generated engine model estimates are passed to both the model verification module 2045 (which may perform one or more functions including range/rate checks, drift checks, noise detection, and/or predictions) and to element 2050 (which weights or blends the model estimates to produce an estimated value of the EGT 2060). A module 2055 may, for example, determine the weighting or blending factors and also receive a self-confidence level indicative of the validity of the determined model estimates produced by the plurality of engine models in 2040. Additionally, the module 2055 which determines the weighting or blending factors may also receive a self-confidence level indicative of the accuracy of the determined estimates produced by the plurality of engine models in 2040. The model accuracy level may represent a measure of the accuracy of the determined estimate based ability to adapt or tune to current operating conditions and the model validity level may represent a measure of the validity of the model based on a predetermined assessment of the inputs to the respective model. Note that the methods for calculating accuracy and validity may be different for different types of models.

As digital twins are allowed some measure of control over twinned physical systems, it may be possible to adjust the controls of the twinned physical system during an operation so that selected components will age substantially equally in order to schedule only one maintenance visit or planned downtime for a plurality of ageing components. Moreover, control may be adjusted and still keep critical parameters, such as flight time, within bounds of fixed envelopes associated with allowed variations.

An “economic operations digital twin” may be used to create demonstrable business value. For example, it might be assigned to operate with and track assets over their lifetimes. The economic operations digital twin software model may include an economic operations optimization module for creating economic data and using it in modeling for synergizing optimal operational control of a twinned physical system and economic considerations involving the physical system (e.g., inspection scheduling, related logistics, assessment and mitigation of financial risk, etc.).

For example, the Exhaust gas Temperature (“EGT”) of a jet turbine engine is usually considered to be the gas temperature (in degrees Celsius) at the turbine's exit. The measurement of the EGT may be an important parameter to optimize fuel economy and/or turbine blade temperature and can provide insight into the RUL of a blade. It has been noted that an EGT excess of only a few degrees can cut turbine blade life in half. Moreover, the measured EGT may be a function of several variables which vary at different times and conditions during take-off, flight, and/or landing. Signal processing may be required to substantially approximate the true EGT value and associated trends over time.

A maximum value operationally permitted the EGT is known as the EGT redline, and the difference between the EGT redline and the maximum EGT during a flight operation, usually during or just after takeoff, is termed the “EGT margin” (in degrees Celsius). During flight, the EGT may be a function of the Outside Air Temperature (“OAT”), with the EGT increasing as the OAT increases.

Engine wear and deterioration may increase with higher EGT, and the increasing engine wear and deterioration may require the engine to be run at a higher EGT to maintain the same thrust performance. This circle can lead to a decreasing EGT margin. Operating in a hot environment may increases the OAT and thereby hastens the decrease in EGT margin, as does flying short leg cycles because the EGT is at its highest for a takeoff and the aircraft will generally do more takeoffs-per-year if its duty roster is composed primarily of multiple short leg cycles as opposed to longer leg cycles requiring fewer takeoffs-per-year.

Note that much of an engine's deterioration rate may be determined by the operator. For example, a higher thrust level may decrease the EGT margin more quickly as compared to operation at lower thrust. This is why the elected derate at takeoff is an important parameter associated with the rate of engine deterioration.

Generally, there are two rate regimes of EGT margin deterioration. The highest rate of EGT margin deterioration is right after a new or refurbished engine is installed. The wear on the turbine blade tips increases the clearance between the tips and the shroud. The increasing clearance reduces the engine's efficiency and the same thrust level requires more fuel and hence a higher EGT. This highest rate of EGT margin deterioration occurs in the first couple of thousand engine flight cycles. The total loss of EGT margin due to this first regime is termed the installation loss of EGT margin. After installation loss, the EGT margin continues to decrease with engine flight cycles but at a substantially constant and lower rate which is termed the steady state loss rate.

An economic operations digital twin may accurately track trends in the EGT of its twinned physical system by sampling EGT and a plurality of variables associated with the EGT over a set of observation times. A trend in the EGT for the specific turbine engine may be identified by removing the effect of the plurality of variables on the EGT data.

The EGT trend measurement process may use sensor data to learn EGT and related internal and external engine parameters. Internal parameters include, for example, core speed, fan speed, derate (a reduction of the engine's rated thrust), cold/hot engine start, bleed settings, etc. External parameters include, for example, OAT, humidity, and/or the altitude of the takeoff run-way. The EGT trend measurement system may use the sensed data to identify trends in the EGT by removing the effect of these parameters on the EGT data.

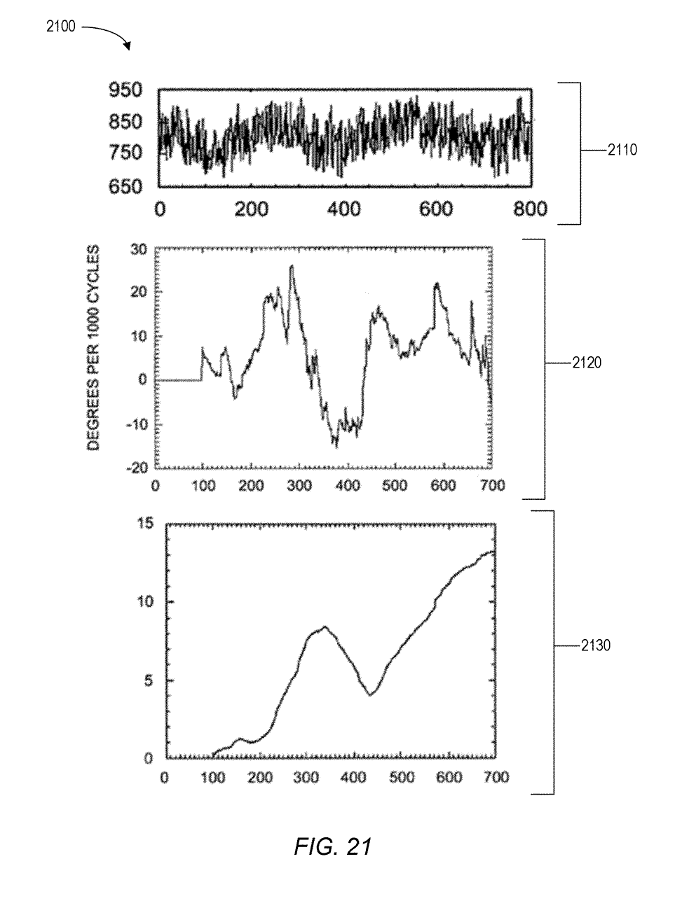

FIG. 21 illustrates 2100 an exemplary graph 2110 of EGT at 795 observation points. The observation points may be, for example, taken about every 5 cycles during take-off of a particular aircraft engine over a period of three years. As illustrated in graph 2110, it may be difficult to identify trends of EGT deterioration due to the inherent noise in the EGT. Graph 2120 illustrates the EGT data after stripping out intrinsic and extrinsic correlations and applying a linear regression fit on the stripped EGT data. Further, graph 2120 illustrates the processed EGT data sampled at observation points 100 through 700. The data of 2120 may further be smoothed to the graph 2130 that may then be utilized for engine deterioration analysis.

An economic operations digital twin's use of embodiments described herein may allow scheduling downtime for a specific turbine engine based on a prediction of engine deterioration corresponding to an identified trend of EGT for that specific turbine engine. The identified trend may be based on sampled data sets of EGT and correlated variables for the specific turbine engine after at least one effect of these correlated variables is removed from the EGT data. Thus, the accurate EGT tracking afforded by such embodiments may be used to better estimate a remaining Time On Wing (“TOW”) and provide data that can be valuable for economic operations used to create demonstrable business value to an aircraft's owner/operator.

An “adaptable digital twin” may refer to a digital twin that can be transferred to another system or class of systems. It is designed to adapt to new scenarios and new system configurations. The adaptation may be accomplished by re-programming the software modules constituting the adaptable digital twin and/or selecting and configuring various software options already resident within the software modules. Note that the re-programming and/or selective reconfiguration may be done while the adaptable digital twin is on-operation.

The adaptable digital twin may detect when unexpected operating scenarios are experienced by a real physical system. The adaptable digital twin may then switch to a different configuration and/or change an underlying system of equations. Investing a digital twin with an ability to adapt may enable unexpected degradations and other unforeseen changes to be quickly accommodated by adapting the physically twinned asset's model to the unexpected environment. According to some embodiments, unexpected situations may be diagnosed by sensors that arrange the data into a plurality of valid operational modes in unusual environments, such as extremely hot weather or very high altitude. Identification of a valid operational mode allows the sensor values to be accepted as valid or judged as false reporting by, for example, examining the residuals formed by subtracting the sensor values from their predicted values for operation in the particular model. According to some embodiments, the use of a plurality of modes may facilitate operation of the system so that it may be defined and tracked more precisely such that operation outside expected parameters may be detected more precisely. As a result, false alarm signals may be reduced.

While degradation of a twinned turbine powered aircraft is expected with time, and may be approximately predictable, degradation may also be unexpected and not previously modeled—such as the turbine deterioration that results from operation in a severely dusty environment. An extreme example of note is when a turbine aircraft engine enters a volcanic dust cloud. For example, some or all of the following four conditions might be noted after a gas turbine engine flies through a volcanic dust cloud:
glassification on hot-section components,
erosion in compressor blading and rotor path,
partial or total blockage of cooling passages, and/or
oil system or bleed air supply contamination.

An adaptable digital twin may first identify this unpredictable problem by, for example, sensing a decrease in the monitored Engine Pressure Ratio (“EPR”) indicating a loss of compressor efficiency and possibly indicative of compressor wear. To maintain the EPR, the PLA would have to be advanced and ideally the adaptable digital twin would identify the cause of the problem by the use of appropriate sensors, or operator entered data, to correlate the problem symptoms with the unpredictable turbine's ingestion of volcanic dust and then the adaptable digital twin could use preprogrammed code or request in-sourced code to assess and track the damage insinuated by the encounter with the volcanic dust. The adaptable digital twin's tracking and damage assessment may address the probability of hot-section component glassification by monitoring or estimating the Turbine Inlet Temperature (“TIT”), the highest temperature inside the turbine engine, during the turbine's trans-volcanic dust cloud passage.

In general, the adaptability of the adaptable digital twin may happen along multiple dimensions, which, for example, could include adapting a performance or life kernel from one asset class in a given family to another sister asset. This could be for, example, from one jet engine component in an engine line to the same component in another engine line or adapting an asset model developed for a specific operating environment to a different operating environment.

There are several methods for transporting performance and associated life kernels from one domain to another for model adaptation. One such example method is called transfer learning associated with: 1) what to transfer, 2) how to transfer, and 3) when to transfer. The “what to transfer” decision may depend to which part of knowledge can be transferred across domains or tasks. For example, some knowledge may specific for individual domains or tasks, while other knowledge may be common between different domains such that they may help improve performance for the target domain or task. After discovering which knowledge can be transferred, learning algorithms may facilitate a transfer of the knowledge (“how to transfer”). The “when to transfer” decision may be based on the particular situations during which transferring operations should be performed.

Transfer learning may contain many specific examples and methodologies that can be applied to the digital twin in its role as an adaptive digital twin. At a general level, transfer learning techniques try to determine an optimal function to translate a given predictive function, T (in our case the model kernel, y̅=f(ā,x̅)), built for the domain Ψₐ with its specific feature set to another domain Ψ_{b} with its own and different feature set. In our example, the domains {Ψᵢ} could represent two gas turbine engine lines or two different environmental conditions.

An “interacting digital twin” might be scalable over an asset class or between classes. One benefit provided by interacting digital twins may be that each of the plurality of the digital twins is updateable by useful results originating in any one of the plurality of the interacting digital twins. A single digital twin may also be construed as an interacting digital twin when it is used as an interactive adjunct equipment in a design process.

A plurality of digital twins is updateable by useful results originating in any one of the plurality of the interacting digital twins. The digital twins may be equipped with data lines that communicate with other digital twins so that results obtained through the running of the plurality of digital twins over an asset class may be used to refine the digital twins' lifting estimation algorithms and then develop more appropriate limits on exceedance envelopes over the magnitudes of the residuals. For example, one digital twin in communication with a plurality of other digital twins within a specified environment might communicate optimal or recommended conditions. The digital twins receiving this information may then evaluate the effectiveness of the received settings based upon their own tuned model or models.

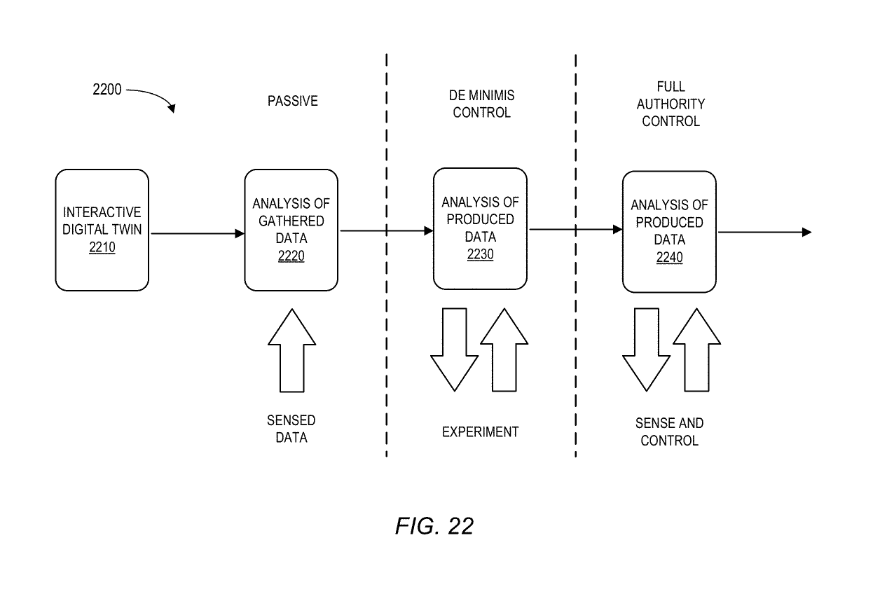

Interacting digital twins may also be used in different domains as illustrated 2200 in FIG. 22. In the first domain, a plurality of interacting digital twins 2210 gathers information from a plurality of twinned physical systems and monitor and evaluate their functioning 2220. If one interacting digital twin discovers that it has knowledge of a better operating control for one of the other twined physical systems, it may communicate this to the interacting digital twin passively monitoring that system. In this mode, the interacting digital twins are considered to be passive in that they monitor but do not actively control.

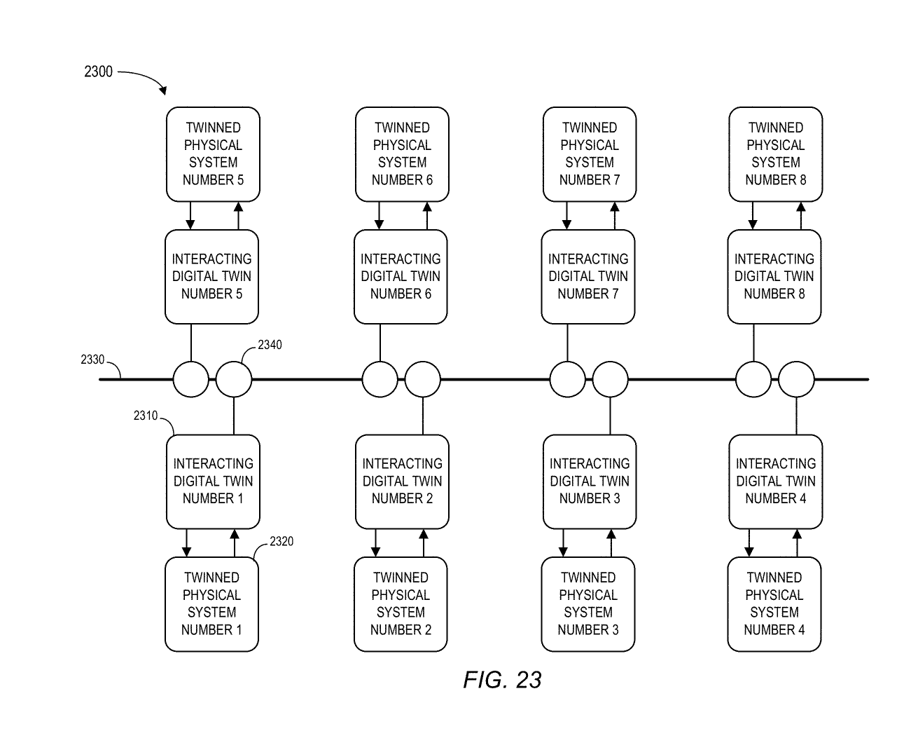

Interacting digital twins may be used to perform cooperative experiments on their twinned physical systems in order to tune the Interacting digital twin models. This mode is termed the “de minimis” mode as the interacting digital twins are permitted to experiment on their twinned physical systems by actively varying the controls in a very limited manner in order to perform the model tuning protocols. 2230 (as opposed to an analysis of produced data associated with full authority control 2240). One example of such an approach is illustrated in FIG. 23 wherein a set of eight Interacting Digital Twins (“IDTs”) 2300 are each monitoring a twinned physical system such as indicated by IDT#1 231010 monitoring its twinned physical system 2320. The Interacting digital twins communicate with each other via a common communications interface 2330, such as the Internet of Things (IoT). The Interacting digital twins are each connected to the common communications interface 2330 by a communications coupler as exemplified by 2340 which connects IDT#1 to the common communications interface 2330. An example of a “de minimis” experiment is described with aid of Table III.

TABLE III
“De minimis” Interacting digital twins Experiment

| | Control | Control | Control | |
|---|---|---|---|---|
| IDT # | #1 | #2 | #3 | Efficiency |
| 1 | +ε | +ε | +ε | + |
| 2 | +ε | +ε | −ε | − |
| 3 | +ε | −ε | +ε | − |
| 4 | +ε | −ε | −ε | + |
| 5 | −ε | +ε | +ε | + |
| 6 | −ε | +ε | −ε | − |
| 7 | −ε | −ε | +ε | − |
| 8 | −ε | −ε | −ε | + |

Table II illustrates the eight interacting digital twins cooperating in a “confounding” experiment on the set of their eight similar twinned systems that are operating at what is presumed to be a monitored optimal efficiency. The experiment involves three controls, Control #1, Control #2, and Control #3, to see if slight changes (with c having a very small magnitude as compared to the controlling value's range) in those controls will produce an increase in the monitored efficiency. The confounding experiment illustrates the time-to-solution advantage provided by a plurality of interacting digital twins over related experiments based on a single controller.

From the example provided in Table III, it can be seen that no single component variation consistently drives the efficiency up or down—but when both Control #2 and Control #3 are adjusted in the same direction, the efficiency is increased. Also, when Control #2 and Control #3 are adjusted in different directions, the efficiency is diminished. The experiment discloses that efficiency of operation may likely be increased by adjusting the values of both Control #2 and Control #3.

As interacting digital twins achieve a status closer to full authority, they may also be used in a situation requiring control of a plurality of stressed similar systems that are used in parallel to develop power or thrust. An imminent failure in one engine may be offset by the other engines with individual regard for their health, i.e., one of the remaining engines may be set to produce more than half of the needed extra thrust. Such an application might be favored in cases of balance of plant equipment, pipeline stations, and/or single vessels, such as a multi-engine aircraft.

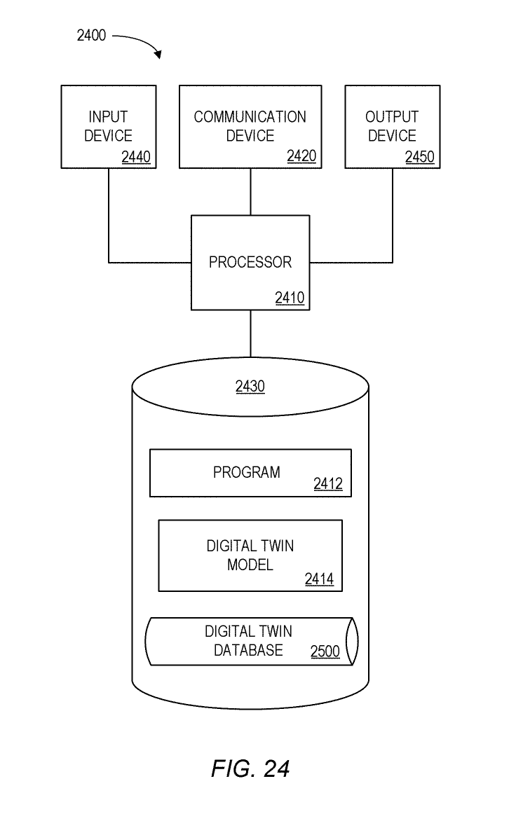

The embodiments described herein may be implemented using any number of different hardware configurations. For example, FIG. 24 is block diagram of a digital twin platform 2400 that may be, for example, associated with the system 100 of FIG. 1. The digital twin platform 2400 comprises a processor 2410, such as one or more commercially available Central Processing Units (“CPUs”) in the form of one-chip microprocessors, coupled to a communication device 2420 configured to communicate via a communication network (not shown in FIG. 24). The communication device 2420 may be used to communicate, for example, with one or more remote user platforms, digital twins, computations associates, etc. The digital twin platform 2400 further includes an input device 2440 (e.g., a computer mouse and/or keyboard to input adaptive and/or predictive modeling information) and/an output device 2450 (e.g., a computer monitor to render display, transmit recommendations, and/or create reports). According to some embodiments, a mobile device and/or personal computer may be used to exchange information with the digital twin platform 2400.

The processor 2410 also communicates with a storage device 2430. The storage device 2430 may comprise any appropriate information storage device, including combinations of magnetic storage devices (e.g., a hard disk drive), optical storage devices, mobile telephones, and/or semiconductor memory devices. The storage device 2430 stores a program 2412 and/or a probabilistic model 2414 for controlling the processor 2410. The processor 2410 performs instructions of the programs 2412, 2414, and thereby operates in accordance with any of the embodiments described herein. For example, the processor 2410 may receive data from one or more sensors that sense values of one or more designated parameters of a twinned physical system. The processor 2410 may also, for at least a selected portion of the twinned physical system, monitor a condition of the selected portion of the twinned physical system and/or assess a remaining useful life of the selected portion based at least in part on the sensed values of the one or more designated parameters. The processor 2410 may transmit information associated with a result generated by the computer processor. Note that the one or more sensors may sense values of the one or more designated parameters, and the computer processor 2410 may perform the monitoring and/or assessing, even when the twinned physical system is not operating.

The programs 2412, 2414 may be stored in a compressed, uncompiled and/or encrypted format. The programs 2412, 2414 may furthermore include other program elements, such as an operating system, clipboard application, a database management system, and/or device drivers used by the processor 2410 to interface with peripheral devices.

As used herein, information may be “received” by or “transmitted” to, for example: (i) the digital twin platform 2400 from another device; or (ii) a software application or module within the digital twin platform 2400 from another software application, module, or any other source.

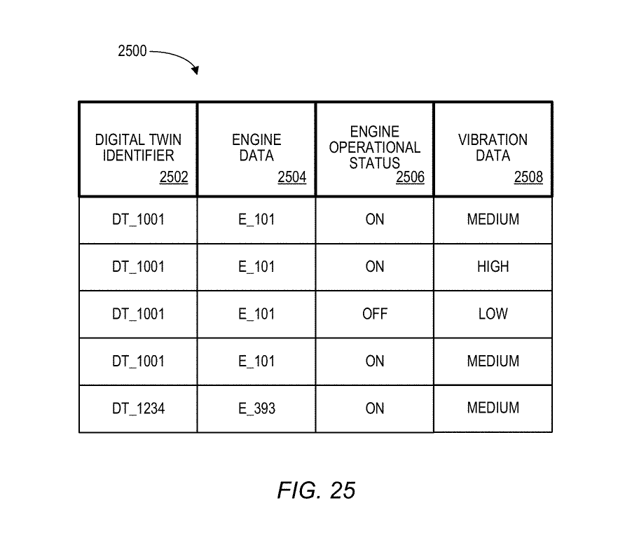

In some embodiments (such as the one shown in FIG. 24), the storage device 2430 further stores a digital twin database 2500. An example of a database that may be used in connection with the digital twin platform 2400 will now be described in detail with respect to FIG. 25. Note that the database described herein is only one example, and additional and/or different information may be stored therein. Moreover, various databases might be split or combined in accordance with any of the embodiments described herein.

Referring to FIG. 25, a table is shown that represents the digital twin database 2500 that may be stored at the digital twin platform 2400 according to some embodiments. The table may include, for example, entries identifying sensor measurement associated with a digital twin of a twinned physical system. The table may also define fields 2502, 2504, 2506, 2508 for each of the entries. The fields 2502, 2504, 2506, 2508 may, according to some embodiments, specify: a digital twin identifier 2502, engine data 2504, engine operational status 2506, and vibration data 2508. The digital twin database 2500 may be created and updated, for example, when a digital twin is created, sensors report values, operating conditions change, etc.

The digital twin identifier 2502 may be, for example, a unique alphanumeric code identifying a digital twin of a twinned physical system. The engine data 2504 might identify a twinned physical engine identifier, a type of engine, an engine model, etc. The engine operational status 2506 might indicate, for example, that the twinned physical engine state is “on” (operation) or “off” (not operational). The vibration data 2508 might indicate data that is collected by sensors and that is processed by the digital twin. Note that vibration data 2508 is collected and processed even when the twinned physical system is “off” (as reflected by the third entry in the database 2500).

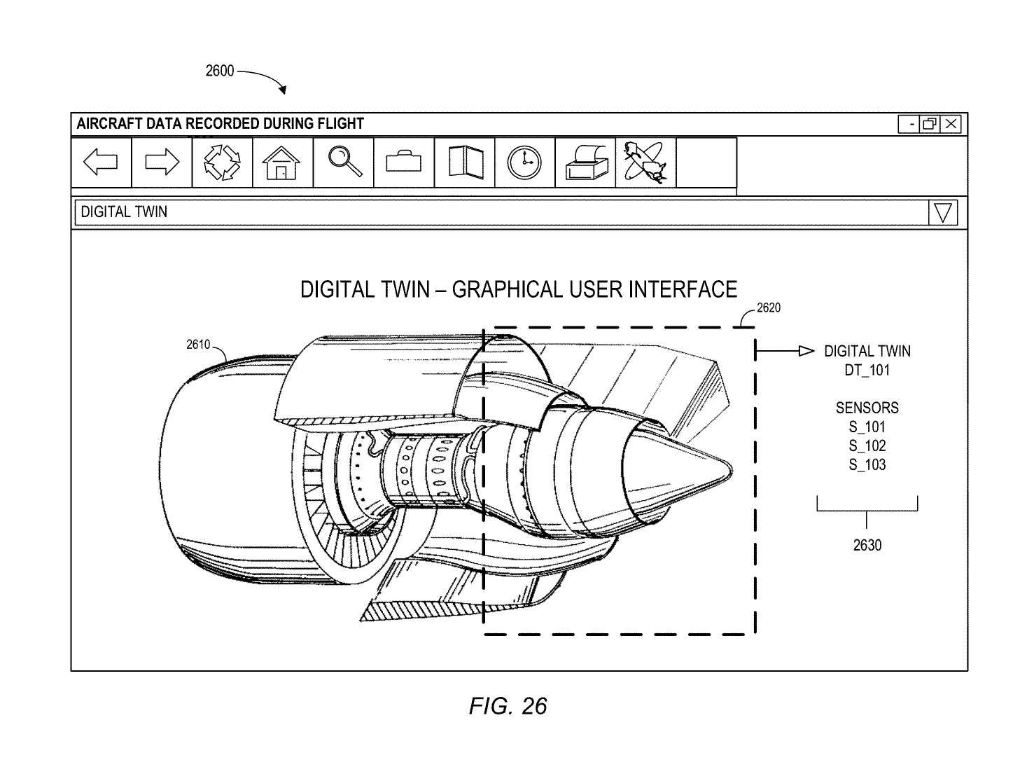

FIG. 26 illustrates an interactive graphical user interface display 2600 according to some embodiments. The display 2600 may include a graphical rendering 2610 of a twinned physical object and a user selectable area 2620 that may be used to identify portions of a digital twin associated with that physical object. A data readout area 2630 might provide further details about the select portions of the digital twins (e.g., sensors within those portion, data values, etc.).

Thus, some embodiments may provide systems and methods to facilitate assessments and/or predictions for a physical system in an automatic and accurate manner.

The following illustrates various additional embodiments of the invention. These do not constitute a definition of all possible embodiments, and those skilled in the art will understand that the present invention is applicable to many other embodiments. Further, although the following embodiments are briefly described for clarity, those skilled in the art will understand how to make any changes, if necessary, to the above-described apparatus and methods to accommodate these and other embodiments and applications.

Although specific hardware and data configurations have been described herein, note that any number of other configurations may be provided in accordance with embodiments of the present invention (e.g., some of the information associated with the databases described herein may be combined or stored in external systems). For example, although some embodiments are focused on EGT, any of the embodiments described herein could be applied to other engine factors related to hardware deterioration, such as engine fuel flow, and to non-engine implementations.

The present invention has been described in terms of several embodiments solely for the purpose of illustration. Persons skilled in the art will recognize from this description that the invention is not limited to the embodiments described, but may be practiced with modifications and alterations limited only by the spirit and scope of the appended claims.

1. An apparatus implementing a digital twin of a twinned physical system, comprising:
one or more sensors to sense values of one or more designated parameters of the twinned physical system;
a computer processor to receive data associated with the one or more sensors and programmed to:
for at least a selected portion of the twinned physical system, execute at least one of: (i) a monitoring process to monitor a condition of the selected portion of the twinned physical system based at least in part on the sensed values of the one or more designated parameters, and (ii) an assessing process to assess a remaining useful life of the selected portion of the twinned physical system based at least in part on the sensed values of the one or more designated parameters; and
a communication port coupled to the computer processor to transmit information associated with a result generated by the computer processor,
wherein the one or more sensors are to sense values of the one or more designated parameters, and the computer processor is to execute at least one of the monitoring and assessing processes, when the twinned physical system is not operating.

2. The apparatus of claim 1, wherein the computer processor is further to execute economic operations optimization software to determine at least one of: (i) an optimal operational control of the twinned physical system, and (ii) optimal operational practices.

3. The apparatus of claim 2, wherein the optimal operational practices comprise at least one of: (i) mission deployment, (ii) inspection, and (iii) maintenance scheduling.

4. The apparatus of claim 1, wherein the digital twin is adaptable to a new scenario or a new system configuration and is transferable to another system or class of systems.

5. The apparatus of claim 1, wherein digital twin is scalable over an asset class or between asset classes and is updatable by another digital twin.

6. The apparatus of claim 1, wherein the digital twin is enabled to exert control over the twinned physical system.

7. The apparatus of claim 1, where the digital twin further comprises a graphical interface engine that enables an operator to:
indicate the selected portion of the twinned physical system; and
display a rendering of the selected portion of the twinned physical system.

8. The apparatus of claim 7, wherein the rendering indicates, for the selected portion of the twinned physical system, at least one of: (i) a flexing displacement, (ii) a stress, (iii) a strain, and (iv) a temperature.

9. The apparatus of claim 1, wherein the digital twin is associated with a computational approximation technique.

10. The apparatus of claim 9, wherein the computational approximation technique comprises at least one of: (i) linearization, (ii) a reduced order model, (iii) fuzzy logic, and (iv) a neural network.

11. The apparatus of claim 1, wherein the computer processor is further adapted to identify a failed sensor.

12. The apparatus of claim 11, wherein the computer processor is further adapted to replace output from the identified failed sensor with data produced by a virtual sensor.

13. The apparatus of claim 1, further comprising:
a system for recording and preserving information acquired while the twinned physical system is operating.

14. A computerized method associated with implementing a digital twin of a twinned physical system, comprising:
sensing, by one or more sensors, one or more designated parameters of the twinned physical system;
for at least a selected portion of the twinned physical system, executing by a computer processor at least one of: (i) a monitoring process to monitor a condition of the selected portion of the twinned physical system based at least in part on the sensed values of the one or more designated parameters, and (ii) an assessing process to assess a remaining useful life of the selected portion of the twinned physical system based at least in part on the sensed values of the one or more designated parameters; and
transmitting, via a communication port coupled to the computer processor, information associated with a result generated by the computer processor,
wherein the one or more sensors are to sense values of the one or more designated parameters, and the computer processor is to execute at least one of the monitoring and assessing processes, when the twinned physical system is not operating.

15. The method of claim 14, wherein the computer processor is further to execute economic operations optimization software to determine at least one of: (i) an optimal operational control of the twinned physical system, and (ii) optimal operational practices associated with mission deployment, inspection, or maintenance scheduling.

16. The method of claim 14, where the digital twin further comprises a graphical interface engine that enables an operator to:
indicate the selected portion of the twinned physical system; and
display a rendering of the selected portion of the twinned physical system, wherein the rendering indicates a flexing displacement, a stress, a strain, or a temperature.

17. The method of claim 14, wherein the digital twin is associated with a computational approximation technique associated with linearization, a reduced order model, fuzzy logic, or a neural network.

18. The method of claim 14, wherein the computer processor is further adapted to identify a failed sensor and to replace output from the identified failed sensor with data produced by a virtual sensor.

19. A non-transitory, computer-readable medium storing instructions that, when executed by a computer processor, cause the computer processor to perform a method associated with implementing a digital twin of a twinned physical system, the method comprising:
sensing, by one or more sensors, one or more designated parameters of the twinned physical system;
for at least a selected portion of the twinned physical system, executing by a computer processor at least one of: (i) a monitoring process to monitor a condition of the selected portion of the twinned physical system based at least in part on the sensed values of the one or more designated parameters, and (ii) an assessing process to assess a remaining useful life of the selected portion of the twinned physical system based at least in part on the sensed values of the one or more designated parameters; and
transmitting, via a communication port coupled to the computer processor, information associated with a result generated by the computer processor,
wherein the one or more sensors are to sense values of the one or more designated parameters, and the computer processor is to execute at least one of the monitoring and assessing processes, when the twinned physical system is not operating.

20. The medium of claim 19, wherein the computer processor is further to execute economic operations optimization software to determine at least one of: (i) an optimal operational control of the twinned physical system, and (ii) optimal operational practices associated with mission deployment, inspection, or maintenance scheduling.

21. The medium of claim 19, where the digital twin further comprises a graphical interface engine that enables an operator to:
indicate the selected portion of the twinned physical system; and
display a rendering of the selected portion of the twinned physical system, wherein the rendering indicates a flexing displacement, a stress, a strain, or a temperature.

22. The medium of claim 19, wherein the digital twin is associated with a computational approximation technique associated with linearization, a reduced order model, fuzzy logic, or a neural network.

23. The medium of claim 19, wherein the computer processor is further adapted to identify a failed sensor and to replace output from the identified failed sensor with data produced by a virtual sensor.
